(19) United States
(12) Patent Application Publication
(10) Pub. No.: US 2014/0015780 A1
(43) Pub. Date: Jan. 16, 2014

(54) USER INTERFACE APPARATUS AND METHOD FOR USER TERMINAL

(71) Applicant: Samsung Electronics Co. Ltd., Suwon-si (KR)

(72) Inventors: Hwa-Kyung KIM, Seoul (KR); Sang-Ok CHA, Suwon-si (KR); Sung-Soo KIM, Bucheon-si (KR); Joo-Yoon BAE, Seoul (KR); Jin-Ha JUN, Seoul (KR); Kyung-Soo LIM, Hwaseong-si (KR)

(21) Appl. No.: 13/939,590

(22) Filed: Jul. 11, 2013

(30) Foreign Application Priority Data
Jul. 13, 2012 (KR) 10-2012-0076514
Aug. 30, 2012 (KR) 10-2012-0095953
Dec. 4, 2012 (KR) 10-2012-0139919

(51) Int. Cl. G06F 3/01

(52) U.S. Cl. CPC G06F 3/01
USPC 345/173; 345/156

(57) ABSTRACT

A User Interface (UI) apparatus and a method for supporting the same at a user terminal supporting a handwriting-based memo function are provided, in which an application is executed, a memo layer is provided during executing the application, a first input event is received in a first area of the memo layer, a second input event is received in a second area of the memo layer, one of the first and second input events is recognized as a handwriting input and the other input event is recognized as a drawing input based on the first and second input events, and a predetermined function from among functions of the application is performed according to an input recognition result.

### CROSS-REFERENCE TO RELATED APPLICATION(S)

This application claims the benefit under 35 U.S.C. §119(a) of a Korean patent application filed on Jul. 13, 2012 in the Korean Intellectual Property Office and assigned Serial No. 10-2012-0076514, a Korean patent application filed on Aug. 30, 2012 in the Korean Intellectual Property Office and assigned Serial No. 10-2012-0095953, and a Korean Patent Application filed on Dec. 4, 2012 in the Korean Intellectual Property Office and assigned Serial No. 10-2012-0139919, the entire disclosure of each of which is hereby incorporated by reference.

### TECHNICAL FIELD

The present disclosure relates to a User Interface (UI) apparatus for a user terminal and a method for supporting the same. More particularly, the present disclosure relates to a handwriting-based UI apparatus in a user terminal and a method for supporting the same.

### BACKGROUND

Along with the recent growth of portable electronic devices, the demand for User Interfaces (UIs) that enable intuitive input/output are increasing. For example, traditional UIs on which information is input by means of an additional device such as a keyboard, a keypad, a mouse, and the like have evolved to intuitive UIs on which information is input by directly touching a screen with a finger or a touch electronic pen or by voice.

In addition, UI technology has been developed to be intuitive and human-centered as well as user-friendly. With the UI technology, a user can communicate with a portable electronic device by voice so as to input intended information or to obtain desired information.

According to the related art, a number of applications are typically installed and new functions are available from the installed applications in a popular portable electronic device such as, for example, a smart phone.

However, a plurality of applications installed in the smart phone are generally executed independently. Accordingly, a new function or result is not provided to a user in conjunction with one another.

For example, a scheduling application allows input of information only on a UI supporting the schedule application despite the user terminal supporting an intuitive UI.

Moreover, a user terminal supporting a memo function enables a user to write down notes using input means such as the user's finger or an electronic pen. However, the user terminal does not offer any specific method for utilizing the notes in conjunction with other applications.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for exchanging information with a user on a handwriting-based User Interface (UI) in a user terminal.

Another aspect of the present disclosure is to provide a UI apparatus and method for executing a specific command using a handwriting-based memo function in a user terminal.

Another aspect of the present disclosure is to provide a UI apparatus and method for exchanging questions and answers with a user by a handwriting-based memo function in a user terminal.

Another aspect of the present disclosure is to provide a UI apparatus and method for receiving a command to process a selected whole or part of a note written on a screen by a memo function in a user terminal.

Another aspect of the present disclosure is to provide a UI apparatus and method for supporting switching between memo mode and command processing mode in a user terminal supporting a memo function through an electronic pen.

Another aspect of the present disclosure is to provide a UI apparatus and method for, while an application is activated, enabling input of a command to control the activated application or another application in a user terminal.

Another aspect of the present disclosure is to provide a UI apparatus and method for analyzing a memo pattern of a user and determining information input by a memory function, taking into account the analyzed memo pattern in a user terminal.

Another aspect of the present disclosure is to provide a UI apparatus and method for determining input information handwritten on a map screen and processing the determined input information, while a map application is activated in a user terminal.

In accordance with an embodiment of the present disclosure, a User Interface (UI) method at a user terminal is provided. The UI method includes a memo layer, while a map is displayed, receiving a first-type input and a second-type input in the memo layer, recognizing one of the first-type input and the second-type input as a handwriting input, recognizing the other of the first-type input and the second-type input as a drawing input, acquiring at least location information according to the handwriting input, acquiring a drawing object area according to the drawing input, and displaying, on the map, an indication of the at least the location information in the drawing object area.

In accordance with another embodiment of the present disclosure, a User Interface (UI) apparatus at a user terminal is provided. The UI method includes a touch panel unit configured to activate a memo layer, while a map is displayed and to receive a first-type input and a second-type input in the memo layer, a command processor configured to recognize one of the first-type input and the second-type input as a handwriting input, and to recognize the other of the first-type input and the second-type input as a drawing input, and an application executer configured to acquire at least location information according to the handwriting input, to acquire a drawing object area according to the drawing input, and to display, on the map, the at least the location information in the drawing object area.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other objects, features, and advantages of certain embodiments of the present disclosure will be more apparent from the following description taken in conjunction with the accompanying drawings, in which:

FIG. 1 is a schematic block diagram of a user terminal supporting handwriting-based Natural Language Interaction (NLI) according to an embodiment of the present disclosure;

FIG. 2 is a block diagram of a user terminal supporting handwriting-based NLI according to an embodiment of the present disclosure;

FIG. 3 illustrates a configuration of a touch pen supporting handwriting-based NLI according to an embodiment of the present disclosure;

FIG. 4 illustrates an operation for recognizing a touch input and a pen touch input through a touch panel and a pen recognition panel according to an embodiment of the present disclosure;

FIG. 5 is a detailed block diagram of a controller in a user terminal supporting handwriting-based NLI according to an embodiment of the present disclosure;

FIG. 6 is a block diagram of a command processor for supporting handwriting-based NLI in a user terminal according to an embodiment of the present disclosure;

FIG. 7 is a flowchart illustrating a control operation for supporting a User Interface (UI) using handwriting-based NLI in a user terminal according to an embodiment of the present disclosure;

FIG. 8 illustrates an example of requesting an operation based on a specific application or function by a memo function according to an embodiment of the present disclosure;

FIG. 9 illustrates an example of a user's actual memo pattern for use in implementing according to an embodiment of the present disclosure;

FIG. 10 illustrates an example in which one symbol may be interpreted as various meanings according to an embodiment of the present disclosure;

FIG. 11 illustrates an example in which input information including text and a symbol in combination may be interpreted as different meanings depending on a symbol according to an embodiment of the present disclosure;

FIG. 12 illustrates examples of utilizing signs and symbols in semiotics according to an embodiment of the present disclosure;

FIG. 13 illustrates examples of utilizing signs and symbols in the fields of mechanical/electrical/computer engineering and chemistry according to an embodiment of the present disclosure;

FIGS. 14, 15A and 15B, 16A and 16B, 17A and 17B, 18A, 18B, and 18C, 19, 20A and 20B, and 21 illustrate operation scenarios of a UI technology according to an embodiment of the present disclosure;

FIGS. 22, 23, 24A and 24B, and 25 illustrate exemplary scenarios of launching an application supporting a memo function after a specific application is activated and then executing an activated application by the launched application according to an embodiment of the present disclosure;

FIG. 26 illustrates a scenario of obtaining intended information in a map application by a memo function according to an embodiment of the present disclosure;

FIG. 27 illustrates activation of a memo function in a map application according to an embodiment of the present disclosure;

FIGS. 28, 29, 30, 31, and 32 illustrate methods for providing a memo-based UI in a map application according to embodiments of the present disclosure;

FIG. 33 illustrates a scenario of inputting intended information by a memo function, while a schedule application is activated according to an embodiment of the present disclosure;

FIGS. 34 and 35 illustrate exemplary scenarios related to semiotics according to an embodiment of the present disclosure;

FIG. 36 is a flowchart illustrating a control operation for providing a memo-based UI in a user terminal according to an embodiment of the present disclosure;

FIG. 37 illustrates an example of distinguishing usages of note content in a user terminal according to an embodiment of the present disclosure;

FIG. 38 illustrates an example of selecting note content to be processed in a user terminal according to an embodiment of the present disclosure;

FIG. 39 illustrates an example of selecting a command to be executed in a user terminal according to an embodiment of the present disclosure;

FIG. 40 illustrates an example of performing an operation as intended by a user based on a memo function in a user terminal according to an embodiment of the present disclosure; and

FIGS. 41A, and 41B, 42A, 42B, 42C, and 42D, 43A, 43B, 43C, 43D, 43E, 43F, and 43G, 44A and 44B, 45A, and 45B, 46A, 46B, 46C, and 46D, and 47A, 47B, and 47C, illustrate various command processing procedures according user requests in a user terminal according to various embodiments of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Various embodiments of the present disclosure will be provided to achieve the above-described technical objects of the present disclosure. For the sake of convenience in describing various embodiments of the present disclosure, defined entities may have the same names, to which the present disclosure is not limited. Thus, the present disclosure can be implemented with same or ready modifications in a system having a similar technical background.

Various embodiments of the present disclosure which will be described later are intended to enable a user to perform a question and answer procedure using a memo function in a user terminal to which handwriting-based User Interface (UI) technology is applied through Natural Language Interaction (NLI) (hereinafter, referred to as ‘handwriting-based NLI’).

NLI generally involves understanding and creation. With the understanding and creation functions, an input is understood and text readily understandable to humans is displayed. Thus, NLI may be considered to be an application that enables a dialogue in a natural language between a human being and an electronic device.

For example, a user terminal executes a command received from a user or acquires information required to execute the input command from the user in a question and answer procedure through NLI.

According to various embodiments of the present disclosure, to apply handwriting-based NLI to a user terminal, switching performed organically between memo mode and command processing mode through handwriting-based NLI is preferred. In the memo mode, a user writes down a note on a screen displayed by an activated application with input means such as, for example, a finger, an electronic pen, or the like in a user terminal. In contrast, in the command processing mode, a note written in the memo mode is processed in conjunction with information associated with a currently activated application.

For example, switching may occur between the memo mode and the command processing mode by pressing a button of an electronic pen. For example, switching may occur between the memo mode and the command processing mode by generating a signal in hardware.

While the following description is given in the context of an electronic pen being used as a major input tool to support a memo function, the present disclosure is not limited to a user terminal using an electronic pen as input means. In other words, it is to be understood that any device capable of inputting information on a touch panel can be used as input means in the various embodiments of the present disclosure.

According to various embodiments of the present disclosure, information may be shared between a user terminal and a user in a preliminary mutual agreement so that the user terminal may receive intended information from the user by exchanging a question and an answer with the user and thus may provide the result of processing the received information to the user through the handwriting-based NLI of the present disclosure. For example, it may be agreed that in order to request operation mode switching, at least one of a symbol, a pattern, text, and a combination thereof is used or a motion (or gesture) is used by a gesture input recognition function. A switching of memo mode to command processing mode or a switching of command processing mode to memo mode may be mainly requested.

In regard to agreement on input information corresponding to a symbol, a pattern, text, or a combination thereof, it is preferred to analyze a user's memo pattern and to consider the analysis result, to thereby enable a user to intuitively input intended information.

Various scenarios in which while a currently activated application is controlled by a memo function based on handwriting-based NLI and the control result is output will be described in detail as separate embodiments of the present disclosure.

For example, a detailed description will be given of a scenario of selecting all or a part of a note and processing the selected note content by a specific command, a scenario of inputting specific information to a screen of a specific application by a memo function, a scenario of processing a specific command in a question and answer procedure using handwriting-based NLI, and the like.

Reference will be made to preferred embodiments of the present disclosure with reference to the attached drawings. A detailed description of a generally known function and structure of the present disclosure will be avoided lest such a description should obscure the subject matter of the present disclosure.

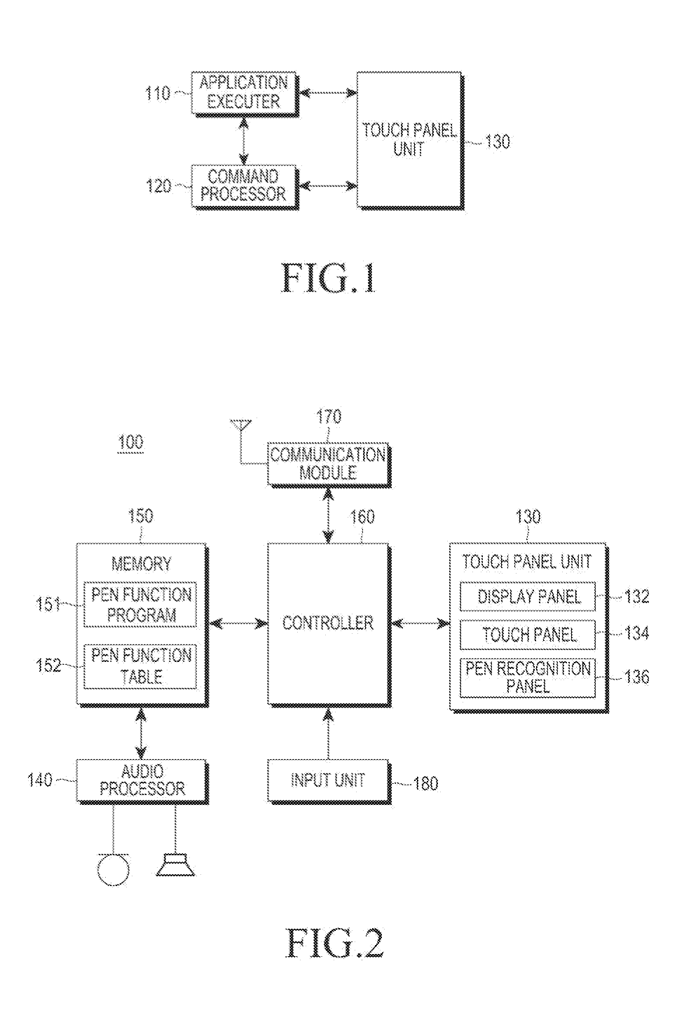

FIG. 1 is a schematic block diagram of a user terminal supporting handwriting-based NLI according to an embodiment of the present disclosure.

Referring to FIG. 1, although only components of the user terminal required to support handwriting-based NLI according to an embodiment of the present disclosure are shown, components may be added to the user terminal in order to perform other functions. Configuring each component illustrated in FIG. 1 in the form of a software function block as well as a hardware function block is possible.

According to various embodiments of the present disclosure, a user terminal includes an application executer 110, a command processor 120, and a touch panel unit 130.

The application executer 110 installs an application received through a network or an external interface in conjunction with a memory (not shown), upon user request. The application executer 110 activates one of installed applications upon user request and controls the activated application according to an external command. As an example, an external command may refer to almost any of externally input commands other than internally generated commands.

For example, the external command may be a command corresponding to information input through handwriting-based NLI by the user as well as a command corresponding to information input through a network. For the sake of convenience in describing various embodiments of the present disclosure, the external command is limited to a command corresponding to information input through handwriting-based NLI by a user, which should not be construed as limiting the present disclosure.

The application executer 110 provides the result of installing or activating a specific application to the user through handwriting-based NLI. For example, the application executer 110 outputs the result of installing or activating a specific application on a display of the touch panel unit 130.

The touch panel unit 130 processes input/output of information through handwriting-based NLI. The touch panel unit 130 performs a display function and an input function. According to various embodiments of the present disclosure, the display function may generally refer to a function of displaying information on a screen and the input function may generally refer to a function of receiving information from a user.

However, it is obvious that the user terminal may include an additional structure for performing the display function and the input function. For example, the user terminal may further include a motion sensing module for sensing a motion input or an optical sensing module for sensing an optical character input. The motion sensing module may include a camera, a proximity sensor, and the like. The sensing module may detect movement of an object within a specific distance from the user terminal using the camera and the proximity sensor. The optical sensing module may detect light and may output a light sensing signal. For the sake of describing various embodiments of the present disclosure, it is assumed that the touch panel unit 130 performs both the display function and the input function without the operation of the touch panel unit 130 being separated into the display function and the input function.

The touch panel unit 130 recognizes specific information or a specific command received from the user and provides the recognized information or command to the application executer 110 and/or the command processor 120.

The information may be information about a note written by the user or information about an answer in a question and answer procedure based on handwriting-based NLI. According to various embodiments of the present disclosure, the information may be information for selecting all or part of a note displayed on a current screen.

The command may be a command requesting installation of a specific application or a command requesting activation of a specific application from among already installed applications. According to various embodiments of the present disclosure, the command may be a command requesting execution of a specific operation, function, and the like supported by a selected application.

The information or command may be input in the form of a line, a symbol, a pattern, or a combination thereof as well as in text. Such a line, symbol, pattern, and the like may be preset by an agreement or learning.

The touch panel unit 130 displays the result of activating a specific application or performing a specific function of the activated application by the application executer 110 on a screen.

The touch panel unit 130 also displays a question or result in a question and answer procedure on a screen. For example, when the user inputs a specific command, the touch panel unit 130 displays the result of processing the specific command, received from the command processor 120 or a question to acquire additional information required to process the specific command. Upon receipt of the additional information as an answer to the question from the user, the touch panel unit 130 provides the received additional information to the command processor 120.

Subsequently, the touch panel unit 130 displays an additional question to acquire other information upon request of the command processor 120 or the result of processing the specific command, reflecting the received additional information.

The command processor 120 receives a user-input text, symbol, figure, pattern, and the like from the touch panel unit 130 and identifies a user-intended input by the text, symbol, figure, pattern, and the like.

For example, the command processor 120 may recognize the user-intended input by natural language processing of the received text, symbol, figure, pattern, and the like. For the natural language processing, the command processor 120 employs handwriting-based NLI. The user-intended input includes a command requesting activation of a specific application or execution of a specific function in a current active application, or an answer to a question.

When the command processor 120 determines that the user-intended input is a command requesting a certain operation, the command processor 120 processes the determined command. Specifically, the command processor 120 commands to the application executer 110 to activate a specific application or to execute a specific function of a current active application, according to the processed command. In this case, the command processor 120 receives a processed result from the application executer 110 and provides the processed result to the touch panel unit 130.

According to various embodiments of the present disclosure, the application executer 110 may provide the processed result directly to the touch panel unit 130, not to the command processor 120.

If additional information is needed to process the determined command, the command processor 120 creates a question to acquire the additional information and provides the question to the touch panel unit 130. Thereafter, the command processor 120 may receive an answer to the question from the touch panel unit 130.

The command processor 120 may continuously exchange questions and answers with the user, that is, may continue a dialogue with the user through the touch panel unit 130 until acquiring sufficient information to process the determined command. For example, the command processor 120 may repeat the question and answer procedure through the touch panel unit 130.

To perform the above-described operation, the command processor 120 adopts handwriting-based NLI by interworking with the touch panel unit 130. For example, the command processor 120 enables questions and answers between a user and an electronic device by a memo function through a handwriting-based natural language interface. For example, the command processor 120 enables a dialogue between a user and an electronic device by a memo function through a handwriting-based natural language interface. The user terminal processes a user command or provides the result of processing the user command to the user in the dialogue.

Regarding the above-described configuration of the user terminal according to the present disclosure, the user terminal may include other components in addition to the command processor 120, the application executer 110, and the touch panel unit 130. The command processor 120, the application executer 110, and the touch panel unit 130 may be configured according to various embodiments of the present disclosure.

For instance, the command processor 120 and the application executer 110 may be incorporated into a controller 160 that provides overall control to the user terminal, or the controller 160 may be configured so as to perform the operations of the command processor 120 and the application executer 110.

The touch panel unit 130 is responsible for processing information input/output involved in applying handwriting-based NLI. The touch panel unit 130 may include a display panel for displaying output information of the user terminal and an input panel on which the user applies an input. The input panel may be implemented into at least one panel capable of sensing various inputs such as a single-touch, a multi-touch input, a drag input, a handwriting input, a drawing input, and the like.

The input panel may be configured to include a single panel capable of sensing both a finger input and a pen input or two panels, for example, a touch panel capable of sensing a finger input and a pen recognition panel capable of sensing a pen input.

An embodiment of the present disclosure will be described, taking as an example a case in which the command processor 120 and the application executer 110 are incorporated into the controller 160 and the touch panel unit 130 is configured into two panels. For example, the touch panel unit 130 may be configured into a touch panel capable of sensing a finger input and a pen recognition panel capable of sensing a pen input.

FIG. 2 is a detailed block diagram of the user terminal supporting handwriting-based NLI according to an embodiment of the present disclosure.

Referring to FIG. 2, a user terminal 100 according to an embodiment of the present disclosure may include the touch panel unit 120, an audio processor unit 140, a memory 150, the controller 160, a communication module 170, and an input unit 180.

The memory 150 may include a pen function program 151 and a pen function table 152.

The touch panel unit 130 may include a display panel 132, a touch panel 134, and a pen recognition panel 136. During executing an application, the touch panel unit 130 may display a memo layer on the touch panel 132, output a first input event by sensing a user input to a first area of the memo layer through at least one of the touch panel 134 and the pen recognition panel 136, and output a second input event by sensing a user input to a second area of the memo layer through at least one of the touch panel 134 and the pen recognition panel 136. For example, each of the first and second input events may be one of a touch input event generated in touch input mode and a pen input event generated in pen input mode.

Regarding sensing a user input through the pen recognition panel 136, the user terminal 100 collects pen state information about a touch pen 20 and pen input recognition information corresponding to a pen input gesture through the pen recognition panel 136. Then the user terminal 100 may identify a predefined pen function command mapped to the collected pen state information and pen recognition information and executes a function corresponding to the pen function command. In addition, the user terminal 100 may collect information about the function type of a current active application as well as the pen state information and the pen input recognition information and may generate a predefined pen function command mapped to the pen state information, pen input recognition information, and function type information.

For the purpose of pen input recognition, the pen recognition panel 136 may be disposed at a predetermined position of the user terminal 100 and may be activated upon generation of a specific event or by default. The pen recognition panel 136 may be prepared over a predetermined area under the display panel 132, for example, over an area covering the display area of the display panel 132. The pen recognition panel 136 may receive pen state information according to approach of the touch pen 20 and a manipulation of the touch pen 20 and may provide the pen state information to the controller 160. Further, the pen recognition panel 136 may receive pen input recognition information according to an input gesture made with the touch pen 20 and provide the pen input recognition information to the controller 160.

The pen recognition panel 136 is configured so as to receive a position value of the touch pen 20 based on electromagnetic induction with the touch pen 20 having a coil. The pen recognition panel 136 may collect an electromagnetic induction value corresponding to the proximity of the touch pen 20 and provide the electromagnetic induction value to the controller 160. The electromagnetic induction value may correspond to pen state information. For example, the pen state information may correspond to information indicating whether the touch pen is in a hovering state or a contact state. As an example, the touch pen 20 hovers over the pen recognition panel 136 or the touch panel 134 by a predetermined gap in the hovering state, whereas the touch pen 20 contacts the display panel 132 or the touch panel 134 or is apart from the display panel 132 or the touch panel 134 by another predetermined gap.

The configuration of the touch pen 20 will be described in greater detail.

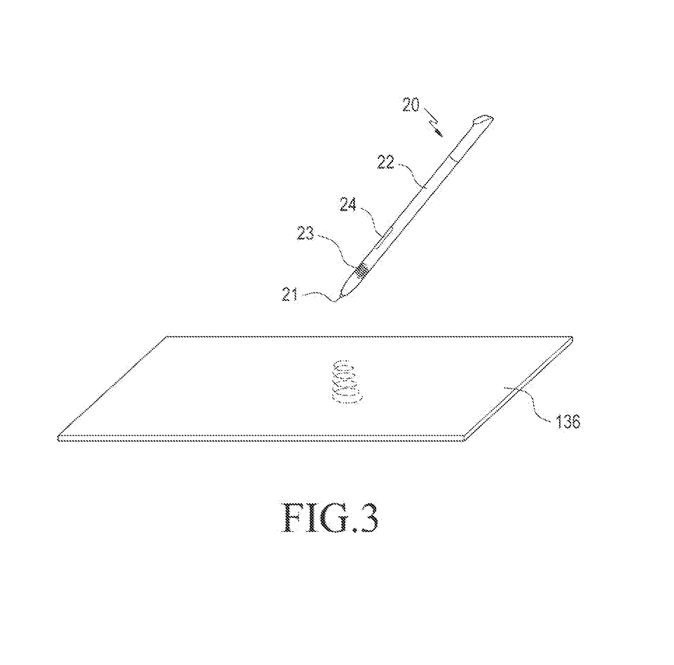

FIG. 3 illustrates a configuration of the touch pen 20 for supporting handwriting-based NLI according to an embodiment of the present disclosure.

Referring to FIG. 3, the touch pen 20 may include a pen body 22, a pen point 21 at an end of the pen body 22, a coil 23 disposed inside the pen body 22 in the vicinity of the pen point 21, and a button 24 for changing an electromagnetic induction value generated from the coil 23.

The touch pen 20 having this configuration according to the present disclosure supports electromagnetic induction. For example, the coil 23 may form a magnetic field at a specific point of the pen recognition panel 136 so that the pen recognition panel 136 may recognize the touched point by detecting the position of the magnetic field.

The pen point 21 contacts the display panel 132, or the pen recognition panel 136 when the pen recognition panel 136 is disposed on the display panel 132, to thereby indicate a specific point on the display panel 132. Because the pen point 21 is positioned at the end tip of the pen body 22 and the coil 23 is apart from the pen point 21 by a predetermined distance, when the user writes grabbing the touch pen 20, the distance between the touched position of the pen point 21 and the position of a magnetic field generated by the coil 23 may be compensated. Owing to the distance compensation, the user may perform an input operation such as handwriting (writing down) or drawing, touch (selection), touch and drag (selection and then movement), and the like, while indicating a specific point of the display panel 132 with the pen point 21. The user may apply a pen input including specific handwritten or drawn content, while touching the display panel 132 with the pen point 21.

When the touch pen 20 comes into a predetermined distance to the pen recognition panel 136, the coil 36 may generate a magnetic field at a specific point of the pen recognition panel 136. Thus, the user terminal 100 may scan the magnetic field formed on the pen recognition panel 136 in real time or at every predetermined interval. The moment the touch pen 20 is activated, the pen recognition panel 136 may be activated. According to various embodiments of the present disclosure, the pen recognition panel 136 may recognize a different pen state according to the proximity of the pen 20 to the pen recognition panel 136.

The user may press the button 24 of the touch pen 20. As the button 24 is pressed, a specific signal may be generated from the touch pen 20 and provided to the pen recognition panel 136. For this operation, a specific capacitor, an additional coil, or a specific device for causing a variation in electromagnetic induction may be disposed in the vicinity of the button 24. When the button 24 is touched or pressed, the capacitor, additional coil, or specific device may be connected to the coil 23 and thus change an electromagnetic induction value generated from the pen recognition panel 136, so that the pressing of the button 24 may be recognized. Or the capacitor, additional coil, or specific device may generate a wireless signal corresponding to pressing of the button 24 and provide the wireless signal to a receiver (not shown) provided in the user terminal 100, so that the user terminal 100 may recognize the pressing of the button 24 of the touch pen 20.

As described above, the user terminal 100 may collect different pen state information according to a different displacement of the touch pen 20. For example, the user terminal 100 may receive information indicating whether the touch pen 20 is in the hovering state or the contact state and information indicating whether the button 24 of the touch pen 20 has been pressed or is kept in its initial state. The user terminal 100 may determine a specific handwritten command based on pen state information received from the touch pen 20 and pen input recognition information corresponding to a pen input gesture, received from the coil 23 of the touch pen 20 and may execute a function corresponding to the determined command.

Referring to FIG. 2 again, when the touch pen 20 is positioned within a first distance (e.g., a predetermined contact distance) from the pen recognition panel 136, the pen recognition panel 136 may recognize that the touch pen 20 is in the contact state. If the touch pen 20 is apart from the pen recognition panel 136 by a distance falling within a range between the first distance and a second distance (e.g., a predetermined proximity distance), the pen recognition panel 136 may recognize that the touch pen 20 is in the hovering state. If the touch pen 20 is positioned beyond the second distance from the pen recognition panel 136, the pen recognition panel 136 may recognize that the touch pen 20 is in air state. In this manner, the pen recognition panel 136 may provide different pen state information according to the distance to the touch pen 20.

Regarding sensing a user input through the touch panel 134, the touch panel 134 may be disposed on or under the display panel 132. The touch panel 134 provides information about a touched position and a touch state according to a variation in capacitance, resistance, or voltage caused by a touch of an object to the controller 160. The touch panel 134 may be arranged in at least a part of the display panel 132. The touch panel 134 may be activated simultaneously with the pen recognition panel 136 or the touch panel 134 may be deactivated when the pen recognition panel 136 is activated, according to an operation mode. Specifically, the touch panel 134 is activated simultaneously with the pen recognition panel 136 in simultaneous mode. In the pen input mode, the pen recognition module 136 is activated, whereas the touch panel 134 is deactivated. In the touch input mode, the touch panel 134 is activated, whereas the pen recognition panel 136 is deactivated.

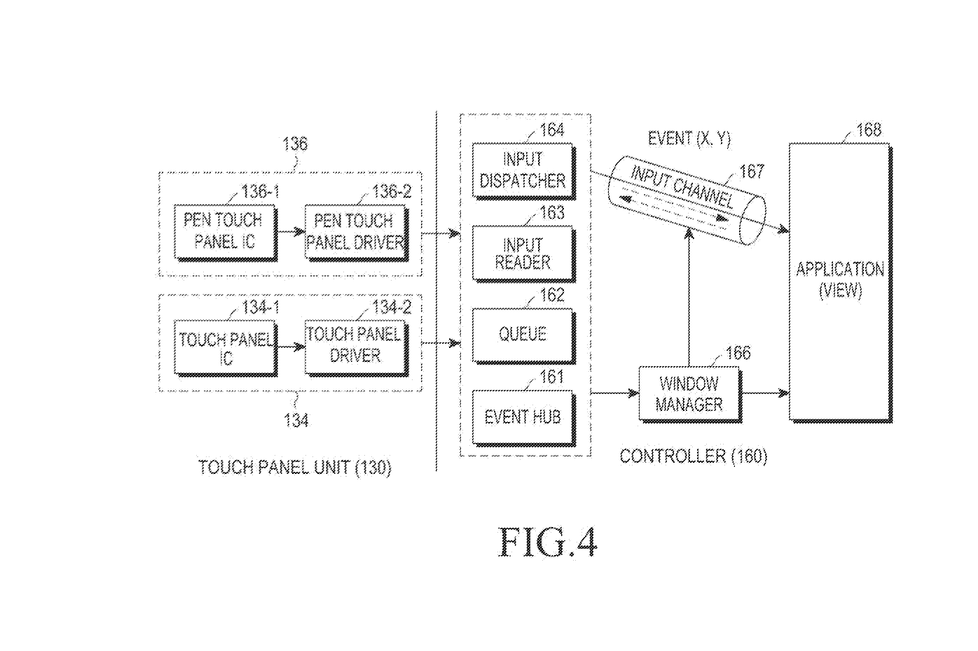

FIG. 4 is a block diagram illustrating an operation for sensing a touch input and a pen touch input through a touch panel and a pen recognition panel according to an embodiment of the present disclosure.

Referring to FIG. 4, the touch panel 134 includes a touch panel Integrated Circuit (IC) 134-1 and a touch panel driver 134-2. The touch panel 134 provides information about a touched position and a touch state according to a variation in capacitance, resistance, or voltage caused by a touch of an object such as a user's finger. For example, the touch panel 134 provides touch input information to the controller 160.

The pen recognition panel 136 includes a pen touch panel IC 136-1 and a pen touch panel driver 136-2. The pen recognition panel 136 may receive pen state information according to proximity and manipulation of the touch pen 20 and provide the pen state information to the controller 160. In addition, the pen recognition panel 136 may receive pen input recognition information according to an input gesture made with the touch pen 20 and provide the pen input recognition information to the controller 160.

The controller 160 includes an event hub 161, a queue 162, an input reader 163, and an input dispatcher 164. The controller 160 receives information from the touch panel 134 and the pen recognition panel 136 through the input reader 163, and generates a pen input event according to the pen state information and pen input recognition information or a touch input event according to the touch input information through the input dispatcher 164. The controller 160 outputs the touch input event and the pen input event through the queue 162 and the event hub 161 and controls input of the pen input event and the touch event through an input channel 167 corresponding to a related application view 168 from among a plurality of application views under management of the window manager 166.

The display panel 132 outputs various screens in relation to operations of the user terminal 100. For example, the display panel 132 may provide various screens according to activation of related functions, including an initial waiting screen or menu screen for supporting functions of the user terminal 100, and a file search screen, a file reproduction screen, a broadcasting reception screen, a file edit screen, a Web page accessing screen, a memo screen, an e-book reading screen, a chatting screen, an e-mail or message writing and reception screen, and the like which are displayed according to selected functions. Each of screens provided by the display panel 132 may have information about a specific function type and the function type information may be provided to the controller 160. If each function of the display panel 132 is activated, the pen recognition panel 136 may be activated according to a pre-setting. Pen input recognition information received from the pen recognition panel 136 may be output to the display panel 132 in its associated form. For example, if the pen recognition information is a gesture corresponding to a specific pattern, an image of the pattern may be output to the display panel 132. Thus, the user may confirm a pen input that the user has applied by viewing the image.

According to various embodiments of the present disclosure, the starting and ending times of a pen input may be determined based on a change in pen state information about the touch pen 20. For example, a gesture input may start in at least one of the contact state and hovering state of the touch pen 20 and may end when one of the contact state and hovering state is released. Accordingly, the user may apply a pen input, contacting the touch pen 20 on the display panel 132 or spacing the touch pen 20 from the display panel 132 by a predetermined gap. For example, when the touch pen 20 moves in a contact-state range, the user terminal 100 may recognize the pen input such as handwriting, drawing, a touch, a touch and drag, and the like according to the movement of the touch pen 20 in the contact state. In contrast, if the touch pen 20 is positioned in a hovering-state range, the user terminal 100 may recognize a pen input in the hovering state.

The memory 150 stores various programs and data required to operate the user terminal 100 according to the present disclosure. For example, the memory 150 may store an Operating System (OS) required to operate the user terminal 100 and function programs for supporting the afore-described screens displayed on the touch panel 132. According to various embodiments of the present disclosure, the memory 150 may store a pen function program 151 to support pen functions and a pen function table 152 to support the pen function program 151.

The pen function program 151 may include various routines to support the pen functions of the present disclosure. For example, the pen function program 151 may include a routine for checking an activation condition for the pen recognition panel 136, a routine for collecting pen state information about the touch pen 20, when the pen recognition panel 136 is activated, and a routine for collecting pen input recognition information by recognizing a pen input according to a gesture made by the touch pen 20. The pen function program 151 may further include a routine for generating a specific pen function command based on the collected pen state information and pen input recognition information and a routine for executing a function corresponding to the specific pen function command. In addition, the pen function program 151 may include a routine for collecting information about the type of a current active function, a routine for generating a pen function command mapped to the collected function type information, pen state information, and pen input recognition information, and a routine for executing a function corresponding to the pen function command.

The routine for generating a pen function command is designed to generate a command, referring to the pen function table 152 stored in the memory 150. The pen function table 152 may include pen function commands mapped to specific terminal functions corresponding to input gestures of the touch pen 20 by a designer or program developer. According to various embodiments of the present disclosure, the pen function table 152 maps input gesture recognition information to pen function commands according to pen state information and function type information so that a different function may be performed according to pen state information and a function type despite the same pen input recognition information. The pen function table 152 may map pen function commands corresponding to specific terminal functions to pen state information and pen input recognition information. For example, the pen function table 152 including only pen state information and pen input recognition information may support execution of a specific function only based on the pen state information and pen input recognition information irrespective of the type of a current active function. As described above, the pen function table 152 may include at least one of a first pen function table including pen function commands mapped to pen state information, function type information, and pen input recognition information and a second pen function table including pen function commands mapped to pen state information and pen input recognition information. The pen function table 152 including pen function commands may be applied selectively or automatically according to a user setting or the type of an executed application program. For example, the user may preset the first or second pen function table. Then the user terminal 100 may perform a pen input recognition process on an input gesture based on the specific pen function table according to the user setting.

Meanwhile, the user terminal 100 may apply the first pen function table when a first application is activated and the pen second function table when a second application is activated according to a design or a user setting. As described above, the pen function table 152 may be applied in various manners according to the type of an activated function. Exemplary applications of the pen function table 152 will be described later in greater detail.

In the case where the user terminal 100 supports a communication function, the user terminal 100 may include the communication module 170. Particularly, when the user terminal 100 supports a mobile communication function, the communication module 110 may include a mobile communication module. The communication module 110 may perform communication functions such as chatting, message transmission and reception, call, and the like. If pen input recognition information is collected from the touch pen 20 while the communication module 170 is operating, the communication module 170 may support execution of a pen function command corresponding to the pen input recognition information under the control of the controller 160.

While supporting the communication functionality of the user terminal 100, the communication module 110 may receive external information for updating the pen function table 152 and provide the received external update information to the controller 160. As described before, a different pen function table 152 may be set according to the function type of an executed application program. Consequently, when a new function is added to the user terminal 100, a new setting related to operation of the touch pen 20 may be required. When a pen function table 152 is given for a new function or a previously installed function, the communication module 110 may support reception of information about the pen function table 152 by default or upon user request.

The input unit 180 may be configured into side keys or a separately procured touch pad. The input unit 180 may include a button for turning on or turning off the user terminal 100, a home key for returning to a home screen of the user terminal 100, and the like. The input unit 180 may generate an input signal for setting a pen operation mode under user control and provide the input signal to the controller 160. Specifically, the input unit 180 may generate an input signal setting one of a basic pen operation mode in which a pen's position is detected without additional pen input recognition and a function is performed according to the detected pen position and a pen operation mode based on one of the afore-described various pen function tables 152. The user terminal 100 retrieves a specific pen function table 152 according to an associated input signal and support a pen operation based on the retrieved pen function table 152.

The audio processor 140 includes at least one of a Speaker (SPK) for outputting an audio signal and a Microphone (MIC) for collecting an audio signal. The audio processor 140 may output a notification sound for prompting the user to set a pen operation mode or an effect sound according to a setting. When the pen recognition panel 136 collects pen input recognition information according to a specific pen input gesture, the audio processor 140 outputs a notification sound corresponding to the pen input recognition information or an effect sound associated with function execution. The audio processor 140 may output an effect sound in relation to a pen input received in real time with a pen input gesture. In addition, the audio processor 140 may control the magnitude of vibration corresponding to a gesture input by controlling a vibration module. The audio processor 140 may differentiate the vibration magnitude according to a received gesture input. For example, when processing different pen input recognition information, the audio processor 140 may set a different vibration magnitude. The audio processor 140 may output an effect sound of a different volume and type according to the type of pen input recognition information. For example, when pen input recognition information related to a currently executed function is collected, the audio processor 140 outputs a vibration having a predetermined magnitude or an effect sound having a predetermined volume. When pen input recognition information for invoking another function is collected, the audio processor 140 outputs a vibration having a relatively large magnitude or an effect sound having a relatively large volume.

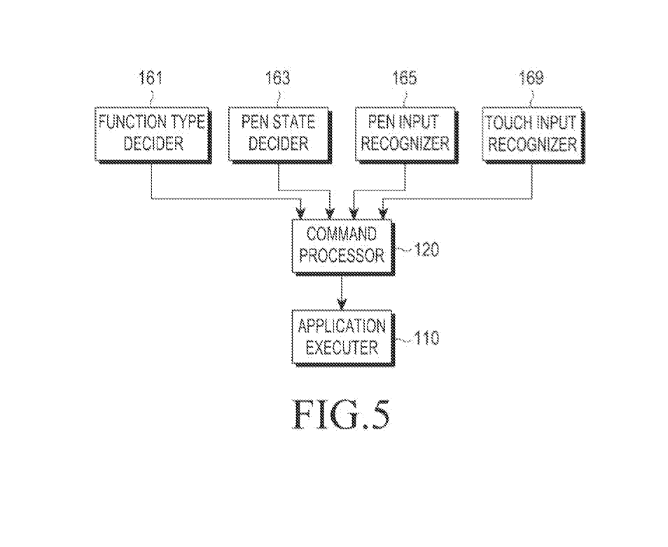

The controller 160 includes various components to support pen functions according to embodiments of the present disclosure and thus processes data and signals for the pen functions and controls execution of the pen functions. Consequently, according to various embodiments of the present invention, the controller 160 may have a configuration as illustrated in FIG. 5.

FIG. 5 is a detailed block diagram of a controller in a user terminal supporting handwriting-based NLI according to an embodiment of the present disclosure.

Referring to FIG. 5, the controller 160 of the present disclosure may include an application executor 110, a command processor 120, a function type decider 161, a pen state decider 163, a pen input recognizer 165, and a touch input recognizer 169.

The function type decider 161 determines the type of a user function currently activated in the user terminal 100. According to various embodiments of the present disclosure, the function type decider 161 collects information about the type of a function related to a current screen displayed on the display panel 132. If the user terminal 100 supports multi-tasking, a plurality of functions may be activated along with activation of a plurality of applications. In this case, the function type decider 161 may collect only information about the type of a function related to a current screen displayed on the display panel 132 and provide the function type information to the command processor 120. If a plurality of screens are displayed on the display panel 132, the function type decider 161 may collect information about the type of a function related to a screen displayed at the foremost layer.

The pen state decider 163 collects information about the position of the touch pen 20 and pressing of the button 24. As described before, the pen state decider 163 may detect a variation in an input electromagnetic induction value by scanning the pen recognition panel 136, determine whether the touch pen 20 is in the hovering state or contact state and whether the button 24 has been pressed or released, and collect pen state information according to the determination. A pen input event corresponding to the collected pen state information may be provided to the command processor 120.

The pen input recognizer 165 recognizes a pen input according to movement of the touch pen 20. The pen input recognizer 165 receives a pen input event corresponding to a pen input gesture according to movement of the touch pen 20 from the pen recognition panel 136 irrespective of whether the touch pen 20 is in the hovering state or contact state, recognizes the pen input, and provides the resulting pen input recognition information to the command processor 120. The pen input recognition information may be single-pen input recognition information obtained by recognizing one object or composite-pen input recognition information obtained by recognizing a plurality of objects. The single-pen input recognition information or composite-pen input recognition information may be determined according to a pen input gesture. For example, the pen input recognizer 165 may generate single-pen input recognition information for a pen input corresponding to continuous movement of the touch pen 20 while the touch pen 20 is kept in the hovering state or contact state. The pen input recognizer 165 may generate composite-pen input recognition information for a pen input corresponding to movement of the touch pen 20 that has been made when the touch pen 20 is switched between the hovering state and the contact state. The pen input recognizer 165 may generate composite-pen input recognition information for a pen input corresponding to movement of the touch pen 20 that has been made when the touch pen 20 is switched from the hovering state to the air state. Or the pen input recognizer 165 may generate composite-pen input recognition information for a plurality of pen inputs that the touch pen 20 has made across the boundary of a range recognizable to the pen recognition panel 136.

The touch input recognizer 169 recognizes a touch input corresponding to a touch or movement of a finger, an object, and the like. The touch input recognizer 169 receives a touch input event corresponding to the touch input, recognizes the touch input, and provides the resulting touch input recognition information to the command processor 120.

The command processor 120 generates a pen function command based on one of the function type information received from the function type decider 161, the pen state information received from the pen state decider 163, and the pen input recognition information received from the pen input recognizer 165 and generates a touch function command based on the touch input recognition information received from the touch input recognizer 169, according to an operation mode. During this operation, the command processor 120 may refer to the pen function table 152 listing a number of pen function commands. According to various embodiments of the present disclosure, the command processor 120 may refer to a first pen function table based on the function type information, pen state information, and pen input recognition information, a second pen function table based on the pen state information, and pen input recognition information, or a third pen function table based on the pen input recognition information, according to a setting or the type of a current active function. The command processor 120 provides the generated pen function command to the application executer 110.

The application executer 110 controls execution of a function corresponding to one of commands including the pen function command and the touch function command received from the command processor 120. The application executer 110 may execute a specific function, invoke a new function, or end a specific function in relation to a current active application.

Operations of the command processor 120 and the application executer 110 will be described below in greater detail.

The command processor 120 will first be described.

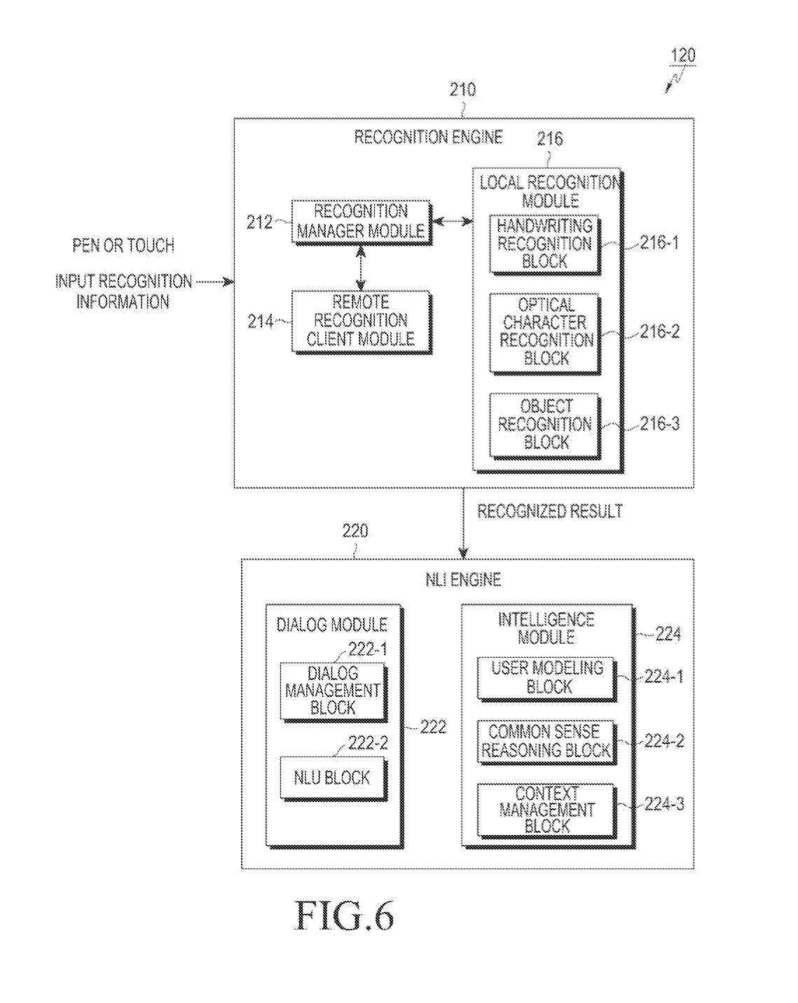

FIG. 6 is a block diagram of a command processor for supporting handwriting-based NLI in a user terminal according to an embodiment of the present disclosure.

Referring to FIG. 6, the command processor 120 supporting handwriting-based NLI includes a recognition engine 210 and an NLI engine 220.

The recognition engine 210 includes a recognition manager module 212, a remote recognition client module 214, and a local recognition module 216. The local recognition module 216 includes a handwriting recognition block 216-1, an optical character recognition block 216-2, and an object recognition block 216-3.

The NLI engine 220 includes a dialog module 222 and an intelligence module 224. The dialog mobile 222 includes a dialog management block 222-1 for controlling a dialog flow and a Natural Language Understanding (NLU) block 222-2 for recognizing a user's intention. The intelligence module 224 includes a user modeling block 224-1 for reflecting user preferences, a common sense reasoning block 224-2, and a context management block 224-3 for reflecting a user situation.

The recognition engine 210 may receive information from a drawing engine corresponding to input means such as an electronic pen and an intelligent input platform such as a camera. The intelligent input platform (not shown) may be an optical character recognizer such as an Optical Character Reader (OCR). The intelligent input platform may read information taking the form of printed text or handwritten text, numbers, or symbols and provide the read information to the recognition engine 210. The drawing engine is a component for receiving an input from input means such as a finger, object, pen, and the like. The drawing engine may detect input information received from the input means and provide the detected input information to the recognition engine 210. Thus, the recognition engine 210 may recognize information received from the intelligent input platform and the touch panel unit 130.

The case where the touch panel unit 130 receives inputs from input means and provides touch input recognition information and pen input recognition information to the recognition engine 210 will be described in an embodiment of the present disclosure, by way of example.

According to various embodiments of the present disclosure, the recognition engine 210 receives at least one of touch input recognition information and pen input recognition information, recognizes the received information, and processes a command according to the recognized result. According to the embodiment of the present disclosure, the recognition engine 210 recognizes note content included in a user-selected are of a currently displayed note or a user-selected command from text, a line, a symbol, a pattern, a figure, or a combination thereof received as information.

The recognition engine 210 outputs a recognized result obtained in the above operation.

For this purpose, the recognition engine 210 includes the recognition manager module 212 for providing overall control to output a recognized result, the remote recognition client module 214, and the local recognition module 216 for recognizing input information. The local recognition module 216 includes at least the handwriting recognition block 216-1 for recognizing handwritten input information, the optical character recognition block 216-2 for recognizing information from an input optical signal, and the object recognition module 216-3 for recognizing information from an input gesture.

The handwriting recognition block 216-1 recognizes handwritten input information. For example, the handwriting recognition block 216-1 recognizes a note that the user has written down on a memory screen with an object such as the touch pen 20 or a finger. The handwritten note may include a handwriting input and a drawing input. The handwriting input refers to handwritten text, symbols, and the like. The drawing input refers to a drawn scribble, closed loop, and the like.

Specifically, the handwriting recognition block 216-1 may receive touch input recognition information or pen input recognition information recognized by the touch input recognizer 169 or the pen input recognizer 165 by means of input events that have been received from the touch panel unit 130, upon generation of an input such as a touch input or pen input on the memo screen. When an input is generated in the first area of the memo screen, the handwriting recognition block 216-1 may receive touch input recognition information or pen input recognition information recognized by the touch input recognizer 169 or the pen input recognizer 165 by means of a first input event output from the touch panel unit 130. When an input is generated in the second area of the memo screen, the handwriting recognition block 216-1 may receive touch input recognition information or pen input recognition information recognized by the touch input recognizer 169 or the pen input recognizer 165 by means of a second input event output from the touch panel unit 130. The touch input recognition information or pen input recognition information may be the coordinates of touched points.

The handwriting recognition block 216-1 stores the coordinates of the touched points touched as strokes, generates a stroke array using the strokes, and then recognizes the handwritten content using a pre-stored handwriting library and a stroke array list including the generated stroke array. The handwriting recognition block 216-1 may recognize note content as handwritten contents or drawn content.

For example, according to various embodiments of the present disclosure, the handwriting recognition block 216-1 may recognize touch input recognition information or pen input recognition information regarding a first input event in the first area of the memo screen as a handwriting input and may recognize touch input recognition information or pen input recognition information regarding a second input event in the second area of the memo screen as a drawing input.

According to various embodiments of the present disclosure, if touch input recognition information or pen input recognition information regarding first and second input events in the first and second areas of the memo screen corresponds to a handwritten form, the handwriting recognition block 216-1 may recognize the input as a handwriting input.

If touch input recognition information or pen input recognition information regarding first and second input events in the first and second areas of the memo screen corresponds to a drawn form, the handwriting recognition block 216-1 may recognize the input as a drawing input.

The handwriting recognition block 216-1 outputs recognized results corresponding to note content and a command in the recognized content.

The optical character recognition block 216-2 receives an optical signal detected by the optical sensing module and outputs an optical character recognized result. The object recognition block 216-3 receives a gesture sensing signal detected by the motion sensing module, recognizes a gesture, and outputs a gesture recognized result. The recognized results output from the handwriting recognition block 216-1, the optical character recognition block 216-2, and the object recognition block 216-3 are provided to the NLI engine 220 or the application executer 110.

The NLI engine 220 determines the intention of the user by processing, for example, analyzing the recognized results received from the recognition engine 210. For example, the NLI engine 220 determines user-intended input information from the recognized results received from the recognition engine 210. Specifically, the NLI engine 220 collects sufficient information by exchanging questions and answers with the user based on handwriting-based NLI and determines the intention of the user based on the collected information.

For this operation, the dialog module 222 of the NLI engine 220 creates a question to make a dialog with the user and provides the question to the user, thereby controlling a dialog flow to receive an answer from the user. The dialog module 222 manages information acquired from questions and answers (e.g., using the dialog management block 222-1). The dialog module 222 also understands the intention of the user by performing a natural language process on an initially received command, taking into account the managed information (e.g., using the NLU block 222-2).

The intelligence module 224 of the NLI engine 220 generates information to be referred to for understanding the intention of the user through the natural language process and provides the reference information to the dialog module 222. For example, the intelligence module 224 models information reflecting a user preference by analyzing a user's habit in making a note (e.g., the user modeling block 224-1), induces information for reflecting common sense (e.g., using the common sense reasoning block 224-2), or manages information representing a current user situation (e.g., using the context management block 224-3).

Therefore, the dialog module 222 may control a dialog flow in a question and answer procedure with the user with the help of information received from the intelligence module 224.

Meanwhile, the application executer 110 receives a recognized result corresponding to a command from the recognition engine 210, searches for the command in a pre-stored synonym table, and reads an ID corresponding to a synonym corresponding to the command, in the presence of the synonym matching to the command in the synonym table. The application executer 110 then executes a method corresponding to the ID listed in a pre-stored method table. Accordingly, the method executes an application corresponding to the command and the note content are provided to the application. The application executer 110 executes an associated function of the application using the note content.

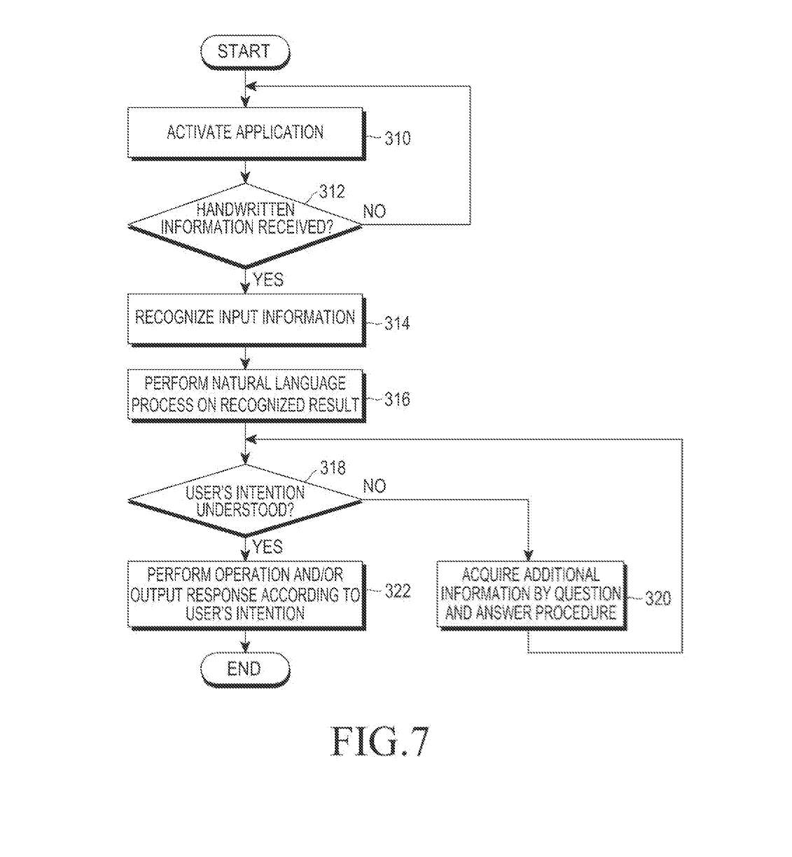

FIG. 7 is a flowchart illustrating a control operation for supporting a UI using handwriting-based NLI in a user terminal according to an embodiment of the present disclosure.

Referring to FIG. 7, the user terminal activates a specific application and provides a function of the activated application at operation 310. The specific application is an application of which the activation has been requested by the user from among applications that were installed in the user terminal upon user request.

For example, the user may activate the specific application by the memo function of the user terminal. For example, the user terminal invokes a memo layer upon user request. Then, upon receipt of ID information of the specific application and information corresponding to an execution command, the user terminal searches for the specific application and activates the detected application. This method is useful in fast executing an intended application from among a large number of applications installed in the user terminal.

As an example, the ID information of the specific application may be the name of the application. The information corresponding to the execution command may be a figure, symbol, pattern, text, and the like preset to command activation of the application.

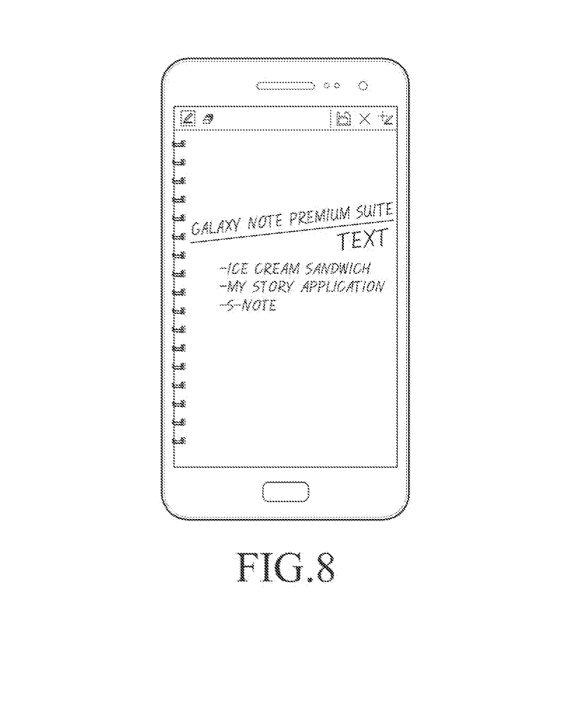

FIG. 8 illustrates an example of requesting an operation based on a specific application or function by the memo function according to an embodiment of the present disclosure.

Referring to FIG. 8, a part of a note written down by the memo function is selected using a line, a closed loop, or a figure and the selected note content are processed using another application. For example, note content “galaxy note premium suite’ is selected using a line and a command is issued to send the selected note content using a text sending application.

If there is no application matching to a user input application in the user terminal, a candidate set of similar applications may be provided to the user so that the user may select an intended application from among the candidate applications.

In another example, a function supported by the user terminal may be executed by the memo function. For this purpose, the user terminal invokes a memo layer upon user request and searches for an installed application according to user-input information.

For instance, a search keyword is input to a memo screen displayed for the memo function in order to search for a specific application among applications installed in the user terminal. Then the user terminal searches for the application matching to the input keyword. For example, if the user writes down “car game” on the screen by the memo function, the user terminal searches for applications related to ‘car game’ among the installed applications and provides the search results on the screen.

In another example, the user may input an installation time, for example, February 2011 on the screen by the memo function. Then the user terminal searches for applications installed in February 2011. For example, when the user writes down ‘February 2011’ on the screen by the memo function, the user terminal searches for applications installed in ‘February 2011’ among the installed applications and provides the search results on the screen.

As described above, activation of or search for a specific application based on a user's note is useful, in the case where a large number of applications are installed in the user terminal.

For more efficient search for applications, the installed applications are preferably indexed. The indexed applications may be classified by categories such as feature, field, function, and the like.

Upon user input of a specific key or gesture, the memo layer may be invoked to allow the user to input ID information of an application to be activated or to input index information to search for a specific application.

Specific applications activated or searched for in the above-described manner include a memo application, a scheduler application, a map application, a music application, and a subway application. According to various embodiments of the present disclosure, the various other applications may be activated and searched.

Upon activation of the specific application, the user terminal monitors input of handwritten information at operation 312. The input information may take the form of a line, symbol, pattern, or a combination thereof as well as text. The user terminal may monitor input of information indicating an area that selects a whole or part of the note written down on the current screen.

If the note is partially or wholly selected, the user terminal continuously monitors additional input of information corresponding to a command in order to process the selected note content at operation 312.

Upon sensing input of handwritten information at operation 312, the user terminal performs an operation for recognizing the detected input information at operation 314. For example, text information of the selected whole or partial note content is recognized or the input information taking the form of a line, symbol, pattern, or a combination thereof in addition to text is recognized. According to various embodiments of the present disclosure, the recognition engine 210 illustrated in FIG. 6 is responsible for recognizing the input information.

Once the user terminal recognizes the detected input information, the user terminal performs a natural language process on the recognized text information to understand the content of the recognized text information at operation 316. The NLI engine 220 is responsible for the natural language process of the recognized text information.

If determining that the input information is a combination of text and a symbol, the user terminal also processes the symbol along with the natural language process.

In the symbol process, the user terminal analyzes an actual memo pattern of the user and detects a main symbol that the user frequently uses by the analysis of the memo pattern. Then the user terminal analyzes the intention of using the detected main symbol and determines the meaning of the main symbol based on the analysis result.

The meaning that the user intends for each main symbol is built into a database, for later use in interpreting a later input symbol. For example, the prepared database may be used for symbol processing.

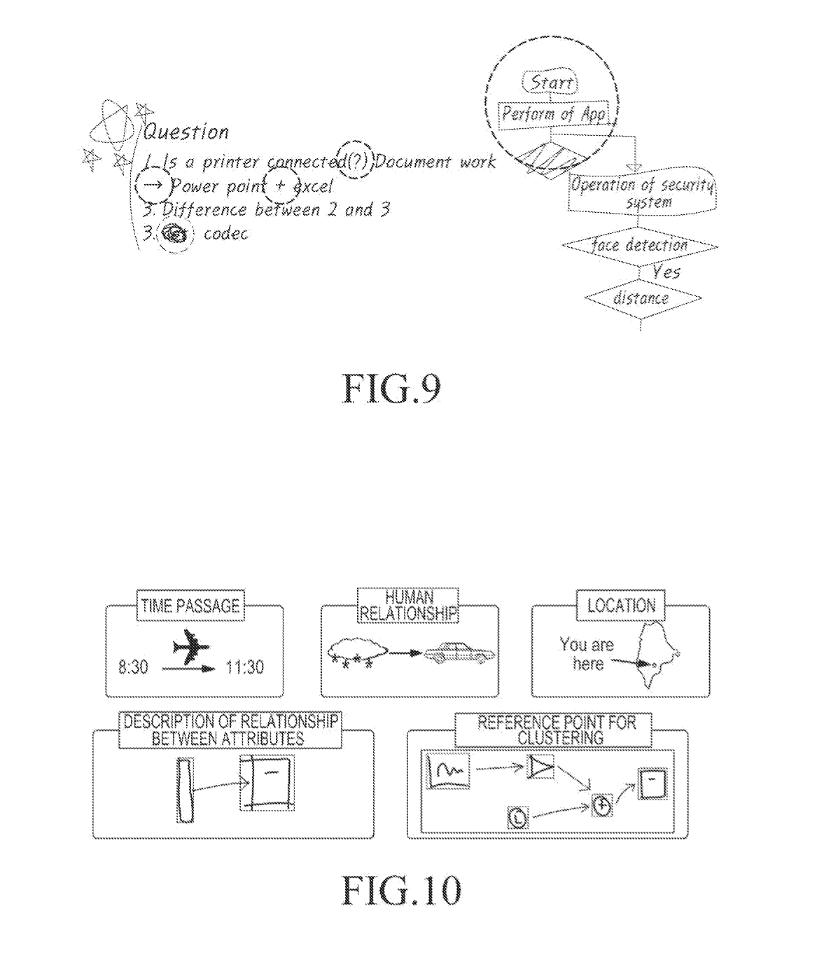

FIG. 9 illustrates an exemplary actual memo pattern of a user for use in implementing embodiments of the present disclosure.

Referring to FIG. 9, the illustrated memo pattern illustrated demonstrates that the user frequently use symbols →, ( ), _, −, +, and ?. For example, symbol → is used for additional description or paragraph separation and symbol ( ) indicates that the content within ( ) is a definition of a term or a description.

The same symbol may be interpreted as different meanings. For example, symbol → may signify ‘time passage’, ‘cause and result relationship’, ‘position’, ‘description of a relationship between attributes’, ‘a reference point for clustering’, ‘change’, and the like.

FIG. 10 illustrates an example in which one symbol may be interpreted as various meanings according to an embodiment of the present disclosure.

Referring to FIG. 10, symbol → may be used in the meanings of time passage, cause and result relationship, position, and the like.

FIG. 11 illustrates an example in which input information including a combination thereof and a symbol may be interpreted as different meanings depending on a symbol according to an embodiment of the present disclosure.

Referring to FIG. 11, user-input information ‘Seoul→Busan’ may be interpreted to imply that ‘Seoul is changed to Busan’ as well as ‘from Seoul to Busan’. The symbol that allows a plurality of meanings may be interpreted, taking into account additional information or the relationship with previous or following information. However, this interpretation may lead to inaccurate assessment of the user's intention.

To overcome the problem, extensive research and efforts on symbol recognition/understanding are required. For example, the relationship between symbol recognition and understanding is under research in semiotics of the liberal arts field and the research is utilized in advertisements, literature, movies, traffic signals, and the like. Semiotics is, in a broad sense, the theory and study of functions, analysis, interpretation, meanings, and representations of signs and symbols, and various systems related to communication.

Signs and symbols are also studied from the perspective of engineering science. For example, research is conducted on symbol recognition of a flowchart and a blueprint in the field of mechanical/electrical/computer engineering. The research is used in sketch (hand-drawn diagram) recognition. Further, recognition of complicated chemical structure formulas is studied in chemistry and this study is used in hand-drawn chemical diagram recognition.

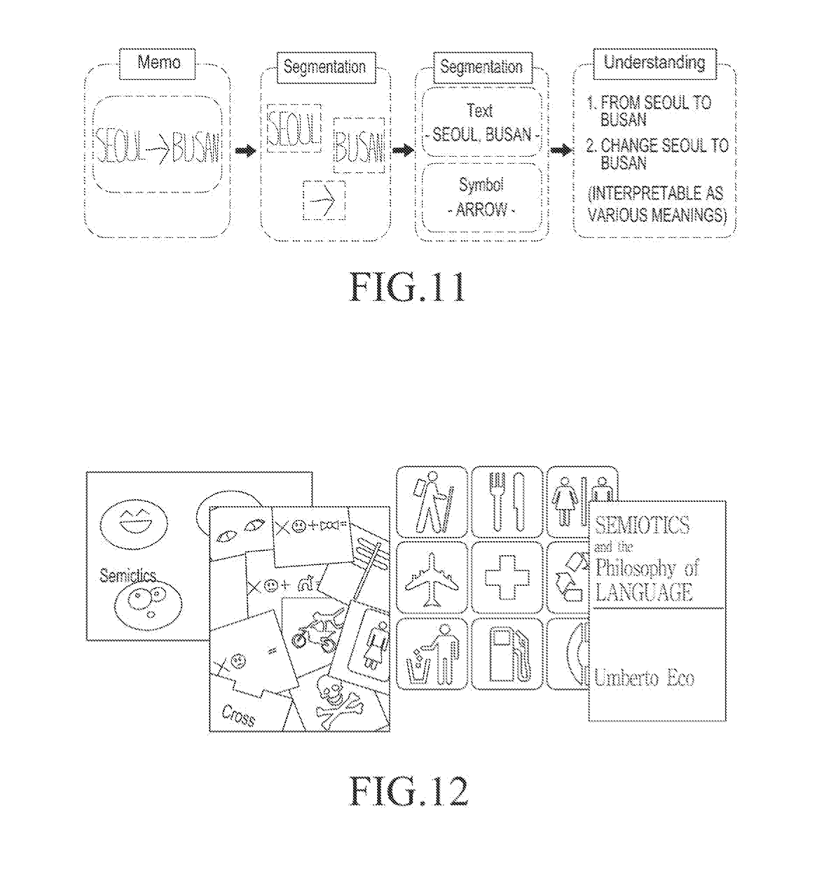

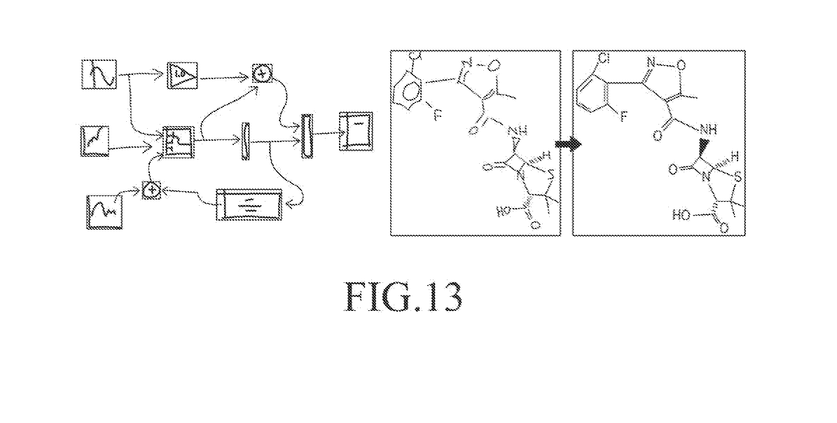

FIG. 12 illustrates examples of utilizing signs and symbols in semiotics according to an embodiment of the present disclosure. FIG. 13 illustrates examples of utilizing signs and symbols in the fields of mechanical/electrical/computer engineering and chemistry according to an embodiment of the present disclosure.

The user terminal understands the content of the user-input information by the natural language process of the recognized result and then assesses the intention of the user regarding the input information based on the recognized content at operation 318.

Once the user terminal determines the user's intention regarding the input information, the user terminal performs an operation corresponding to the user's intention or outputs a response corresponding to the user's intention at operation 322. After performing the operation corresponding to the user's intention, the user terminal may output the result of the operation to the user.

In contrast, if the user terminal fails to access the user's intention regarding the input information, the user terminal acquires additional information by a question and answer procedure with the user to determine the user's intention at operation 320. For this purpose, the user terminal creates a question to ask the user and provides the question to the user. When the user inputs additional information by answering the question, the user terminal re-assesses the user's intention, taking into account the new input information in addition to the content understood previously by the natural language process.

While not shown, the user terminal may additionally perform operations 314 and 316 to understand the new input information.

Until assessing the user's intention accurately, the user terminal may acquire most of information required to determine the user's intention by exchanging questions and answers with the user at operation 320. For example, the user terminal may acquire most of information required to determine the user's intention by making a dialog with the user at operation 320.

Once the user terminal determines the user's intention in the afore-described question and answer procedure, the user terminal performs an operation corresponding to the user's intention or outputs a response result corresponding to the user's intention to the user at operation 322.

The configuration of the UI apparatus in the user terminal and the UI method using handwriting-based NLI in the UI apparatus may be considered in various scenarios.

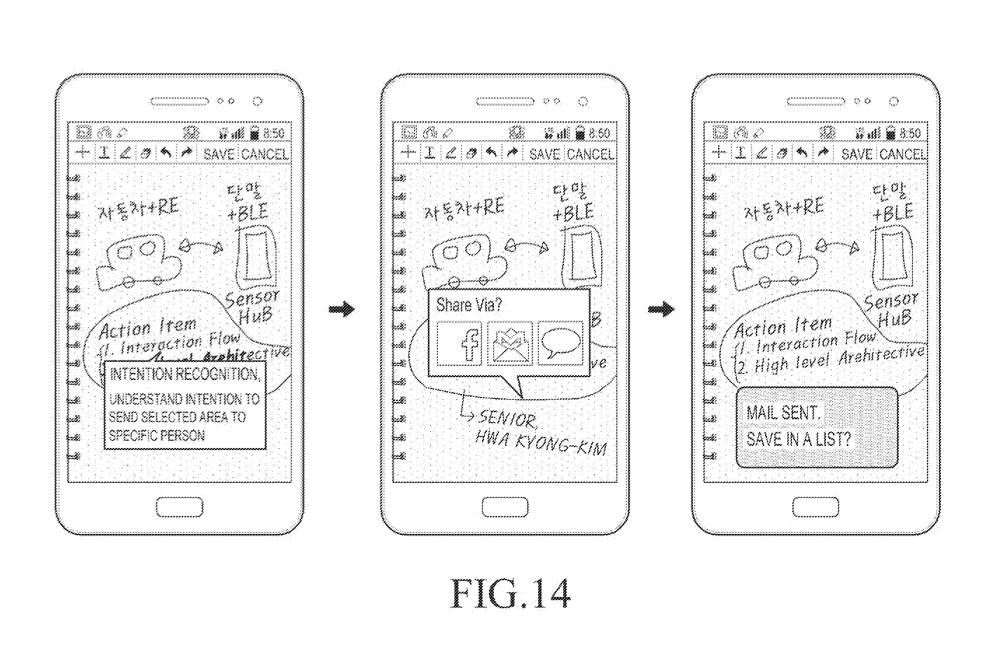

FIGS. 14, 15A and 15B, 16A and 16B, 17A and 17B, 18A, 18B, and 18C, 19, 20A and 20B, and 21 illustrate operation scenarios of a UI technology according to an embodiment of the present disclosure.

Referring to FIGS. 14, 15A and 15B, 16A and 16B, 17A and 17B, 18A, 18B, and 18C, 19, 20A and 20B, and 21 illustrate examples of processing a note written down in an application supporting a memo function by launching another application.

For example, FIG. 14 illustrates a scenario of sending a part of a note written down by the memo function by mail at the user terminal.

Referring to FIG. 14, the user writes down a note on the screen of the user terminal by the memo function and selects a part of the note by means of a line, symbol, closed loop, and the like. For example, a partial area of the whole note may be selected by drawing a closed loop, thereby selecting the content of the note within the closed loop.

Then the user inputs a command requesting processing the selected content using a preset or intuitively recognizable symbol and text. For example, the user draws an arrow indicating the selected area and writes text indicating a person (Senior, Hwa Kyong-KIM).

Upon receipt of the information, the user terminal interprets the user's intention as meaning that the note content of the selected area are to be sent to ‘Senior, Hwa Kyong-KIM’. After determining the user's intention, the user terminal extracts recommended applications capable of sending the selected note content from among installed applications. Then the user terminal displays the extracted recommended applications so that the user may request selection or activation of a recommended application.

When the user selects one of the recommended applications, the user terminal launches the selected application and sends the selected note content to ‘Senior, Hwa Kyong-KIM’ by the application.

If information about the recipient is not pre-registered, the user terminal may ask the user a mail address of ‘Senior, Hwa Kyong-KIM’. In this case, the user terminal may send the selected note content in response to reception of the mail address from the user.

After processing the user's intention, the user terminal displays the processed result on the screen so that the user may confirm appropriate processing conforming to the user's intention. For example, the user terminal asks the user whether to store details of the sent mail in a list, while displaying a message indicating completion of the mail sending. When the user requests to store the details of the sent mail in the list, the user terminal registers the details of the sent mail in the list.

The above scenario can help to increase throughput by allowing the user terminal to send necessary content of a note written down during a conference to the other party without the need for shifting from one application to another and store details of the sent mail through interaction with the user.

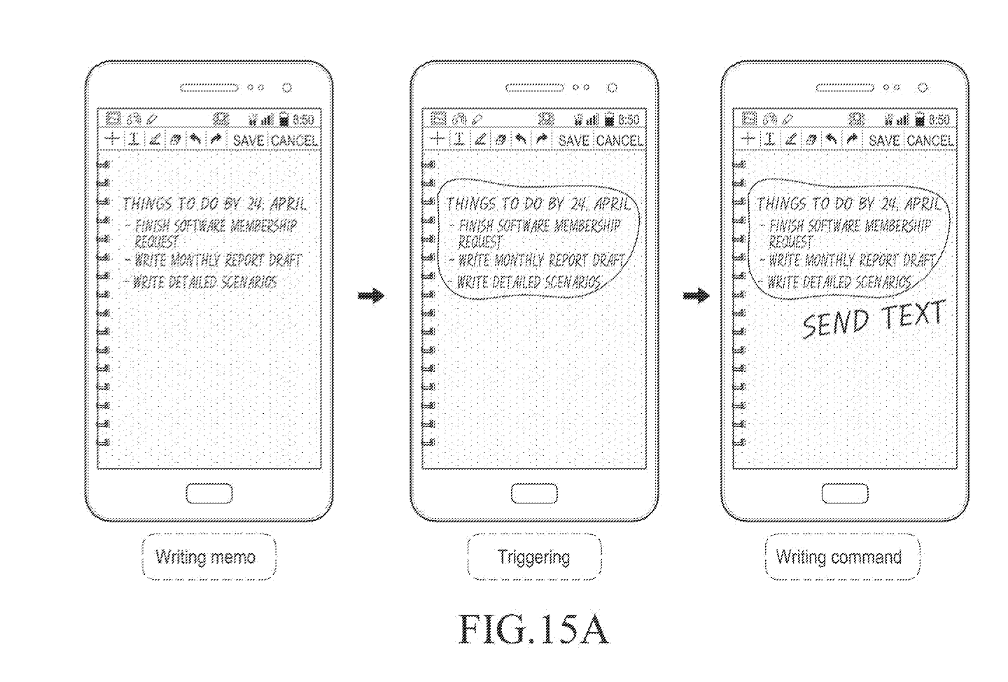

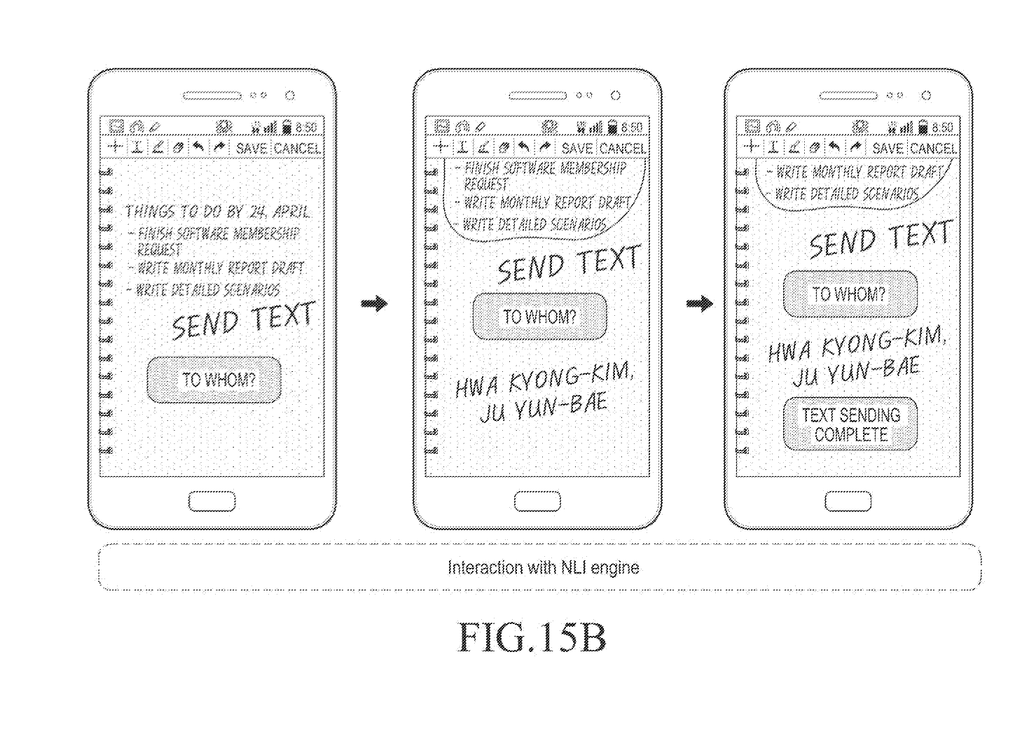

FIGS. 15A and 15B illustrate a scenario in which the user terminal sends a whole note by the memo function.

Referring to FIG. 15A, the user writes down a note on a screen by the memo function (e.g., Writing memo). Then the user selects the whole note using a line, symbol, closed loop, and the like (e.g., Triggering). For example, when the user draws a closed loop around the full note, the user terminal may recognize that the whole content of the note within the closed loop are selected.

The user requests text-sending of the selected content by writing down a preset or intuitively recognizable text, for example, ‘send text’ (e.g., Writing command).

Referring to FIG. 15B, the NLI engine that configures a UI based on user-input information recognizes that the user intends to send the content of the selected area in text. Then the NLI engine further acquires necessary information by exchanging a question and an answer with the user, determining that information is insufficient for text sending (e.g., Interaction with NLI engine). For example, the NLI engine asks the user to whom to send the text, for example, by ‘To whom?’.

The user inputs information about a recipient to receive the text by the memo function as an answer to the question. The name or phone number of the recipient may be directly input as the information about the recipient. Referring to FIG. 15B, ‘Hwa Kyong-KIM’ and ‘Ju Yun-BAE” are input as recipient information.

The NLI engine detects phone numbers mapped to the input names ‘Hwa Kyong-KIM’ and ‘Ju Yun-BAE” in a directory and sends text having the selected note content as a text body to the phone numbers. If the selected note content are an image, the user terminal may additionally convert the image to text so that the other party may recognize.

Upon completion of the text sending, the NLI engine displays a notification indicating the processed result, for example, a message ‘text has been sent’. Therefore, the user can confirm that the process has been appropriately completed as intended.

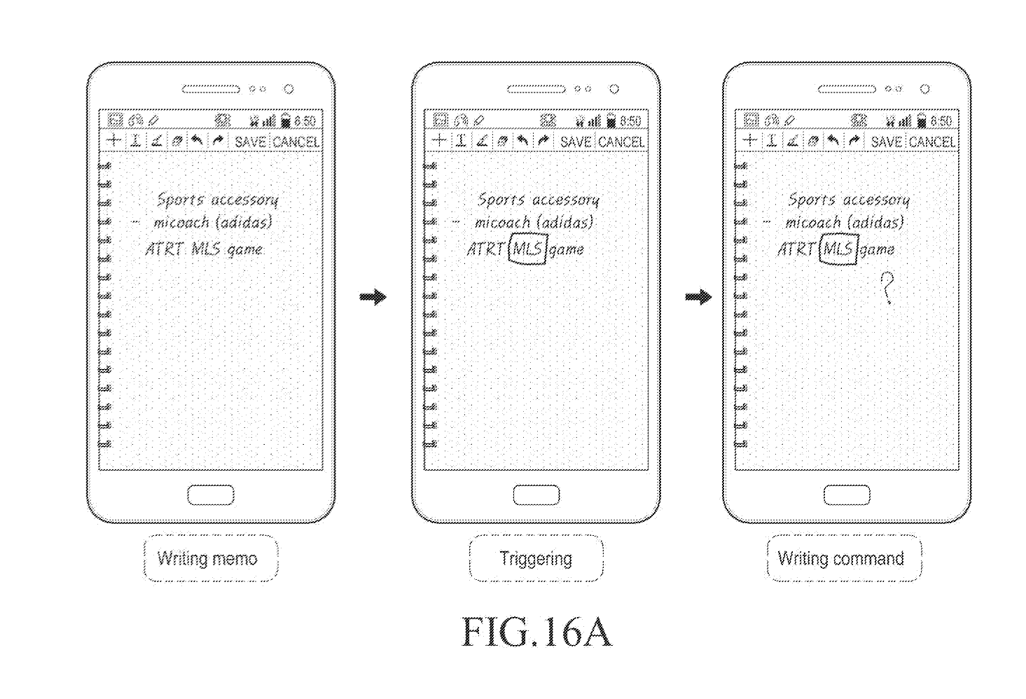

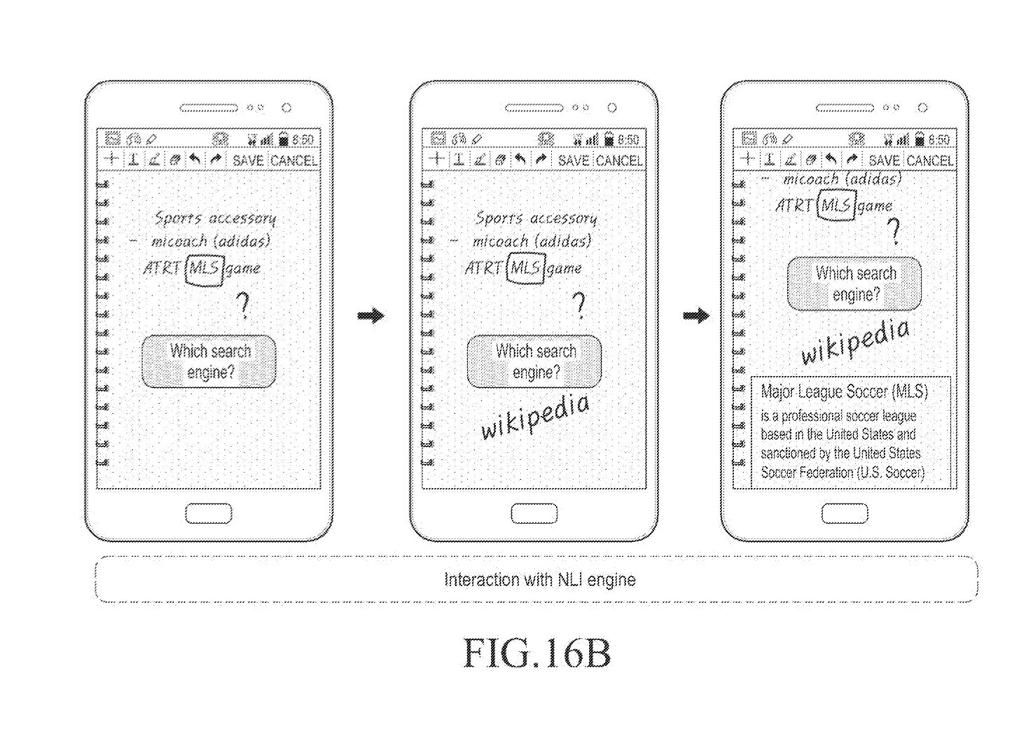

FIGS. 16A and 16B illustrate a scenario of finding the meaning of a part of a note by the memo function at the user terminal.

Referring to FIG. 16A, the user writes down a note on a screen by the memo function (e.g., Writing memo). Then the user selects a part of the note using a line, symbol, closed loop, and the like (e.g., Triggering). For example, the user may select one word written in a partial area of the note by drawing a closed loop around the word.

The user requests the meaning of the selected text by writing down a preset or intuitively recognizable symbol, for example, ‘?’ (e.g., Writing command).

Referring to FIG. 16B, the NLI engine that configures a UI based on user-input information asks the user which engine to use in order to find the meaning of the selected word. For this purpose, the NLI engine uses a question and answer procedure with the user (e.g., Interaction with NLI engine). For example, the NLI engine prompts the user to input information selecting a search engine by displaying ‘Which search engine?’ on the screen.

The user inputs ‘wikipedia’ as an answer by the memo function. Thus, the NLI engine recognizes that the user intends to use ‘wikipedia’ as a search engine using the user input as a keyword. The NLI engine finds the meaning of the selected ‘NILS’ using ‘wikipedia’ and displays search results. Therefore, the user is aware of the meaning of the ‘NILS’ from the information displayed on the screen.

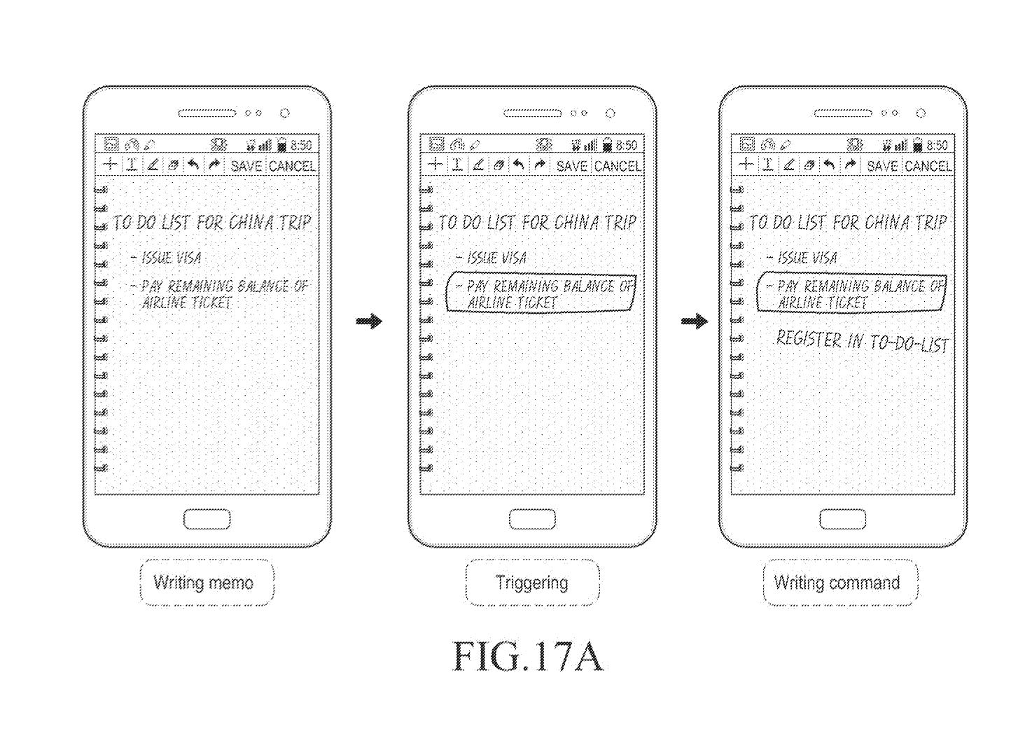

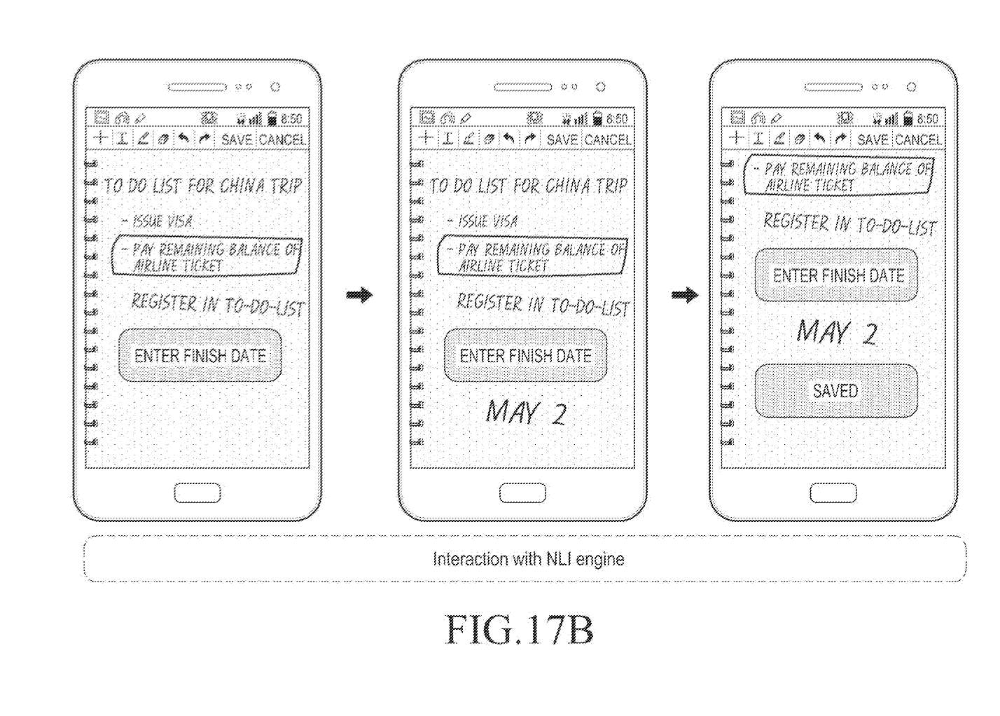

FIGS. 17A and 17B illustrate a scenario of registering a part of a note written down by the memo function as information for another application at the user terminal.

Referring to FIG. 17A, the user writes down a to-do-list of things to prepare for a China trip on a screen of the user terminal by the memo function (e.g., Writing memo). Then the user selects a part of the note using a line, symbol, closed loop, and the like (e.g., Triggering). For example, the user may select ‘pay remaining balance of airline ticket’ in a part of the note by drawing a closed loop around the text.

The user requests registration of the selected note content in a to-do-list by writing down preset or intuitively recognizable text, for example, ‘register in to-do-list’ (e.g., Writing command).

Referring to FIG. 17B, The NLI engine that configures a UI based on user-input information recognizes that the user intends to request scheduling of a task corresponding to the selected content of the note. Then the NLI engine further acquires necessary information by a question and answer procedure with the user, determining that information is insufficient for scheduling (e.g., Interaction with NLI engine). For example, the NLI engine prompts the user to input information by asking a schedule, for example, ‘Enter finish date’.

The user inputs ‘May 2’ as a date on which the task should be performed by the memo function as an answer. Thus, the NLI engine stores the selected content as a thing to do by May 2, for scheduling.

After processing the user's request, the NLI engine displays the processed result, for example, a message ‘saved’. Therefore, the user is aware that an appropriate process has been performed as intended.

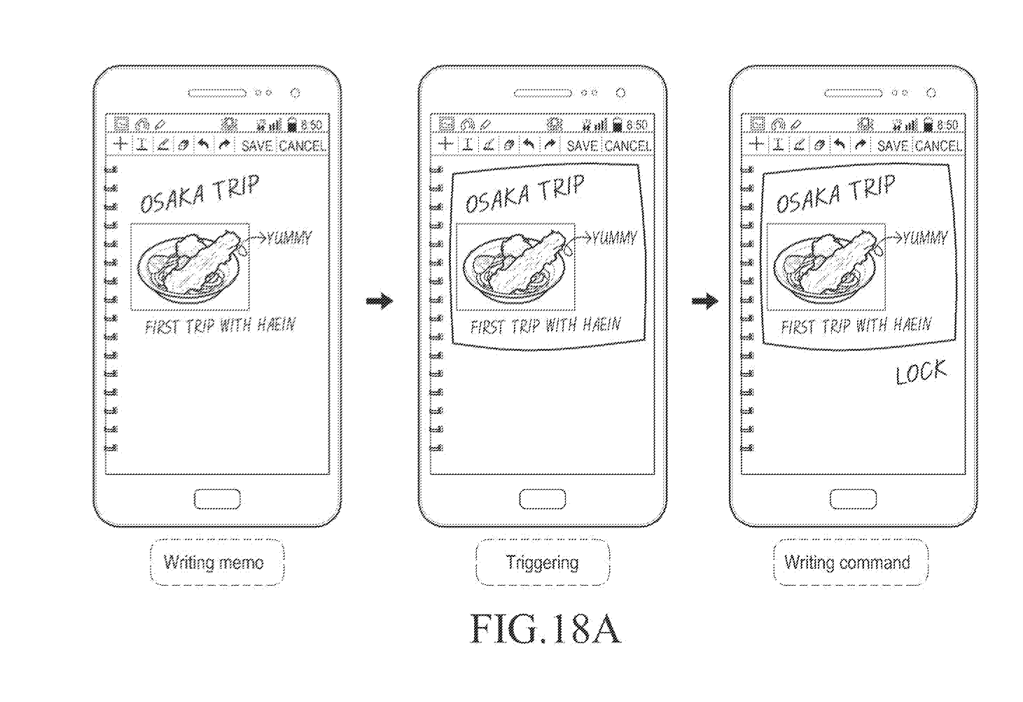

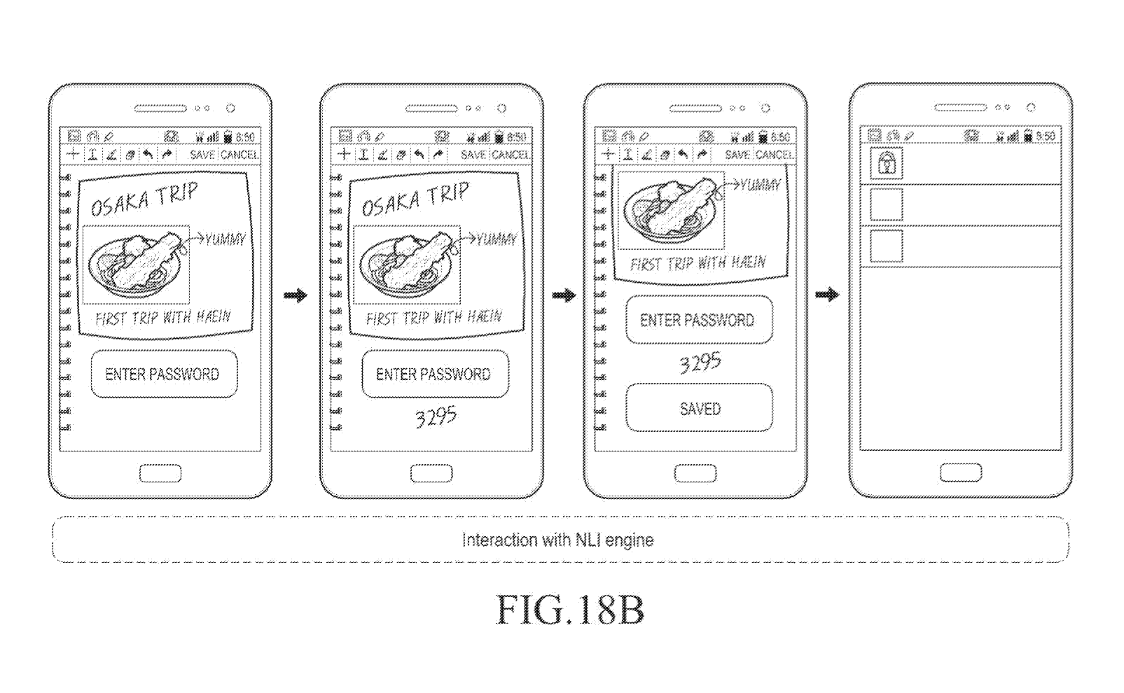

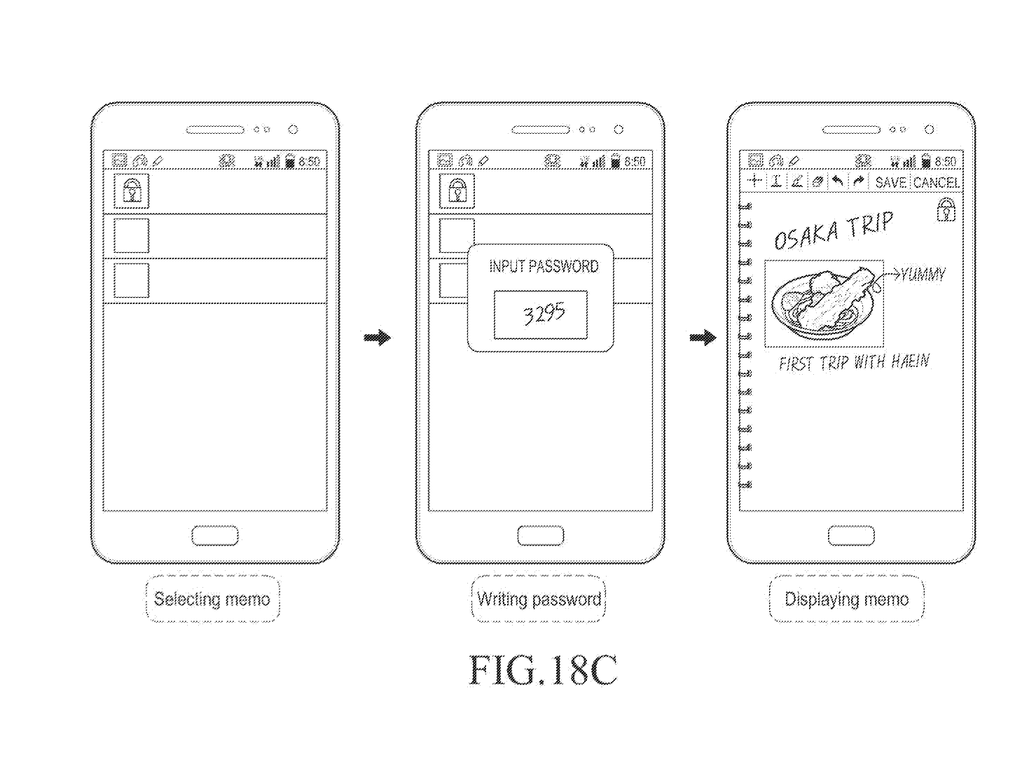

FIGS. 18A, 18B, and 18C illustrate a scenario of storing a note written down by the memo function using a lock function at the user terminal FIG. 18C illustrates a scenario of reading the note stored by the lock function.

Referring to FIG. 18A, the user writes down the user's experiences during an Osaka trip using a photo and a note on a screen of the user terminal by the memo function (e.g., Writing memo). Then the user selects the whole note or a part of the note using a line, symbol, closed loop, and the like (e.g., Triggering). For example, the user may select the whole note by drawing a closed loop around the note.

The user requests registration of the selected note content by the lock function by writing down preset or intuitively recognizable text, for example, ‘lock’ (e.g., Writing command).

The NLI engine that configures a UI based on user-input information recognizes that the user intends to store the content of the note by the lock function. Referring to FIG. 18B, then the NLI engine further acquires necessary information by a question and answer procedure with the user, determining that information is insufficient for setting the lock function (e.g., Interaction with NLI engine). For example, the NLI displays a question asking a password, for example, a message ‘Enter password’ on the screen to set the lock function.

The user inputs ‘3295’ as the password by the memo function as an answer in order to set the lock function. Thus, the NLI engine stores the selected note content using the password ‘3295’.

After storing the note content by the lock function, the NLI engine displays the processed result, for example, a message ‘Saved’. Therefore, the user is aware that an appropriate process has been performed as intended.

Referring to FIG. 18C, the user selects a note from among notes stored by the lock function (e.g., Selecting memo). Upon selection of a specific note by the user, the NLI engine prompts the user to enter the password by a question and answer procedure, determining that the password is needed to provide the selected note (e.g., Writing password). For example, the NLI engine displays a memo window in which the user may enter the password.

When the user enters the valid password, the NLI engine displays the selected note on a screen (e.g., Displaying memo).

FIG. 19 illustrates a scenario of executing a specific function using a part of a note written down by the memo function at the user terminal.

Referring to FIG. 19, the user writes down a note on a screen of the user terminal by the memo function (e.g., Writing memo). Then the user selects a part of the note using a line, symbol, closed loop, and the like (e.g., Triggering). For example, the user may select a phone number ‘010-9530-0163’ in a part of the note by drawing a closed loop around the phone number.

The user requests dialing of the phone number by writing down preset or intuitively recognizable text, for example, ‘call’ (e.g., Writing command).

The NLI engine that configures a UI based on user-input information recognizes the selected phone number by translating it into a natural language and attempts to dial the phone number ‘010-9530-0163’.

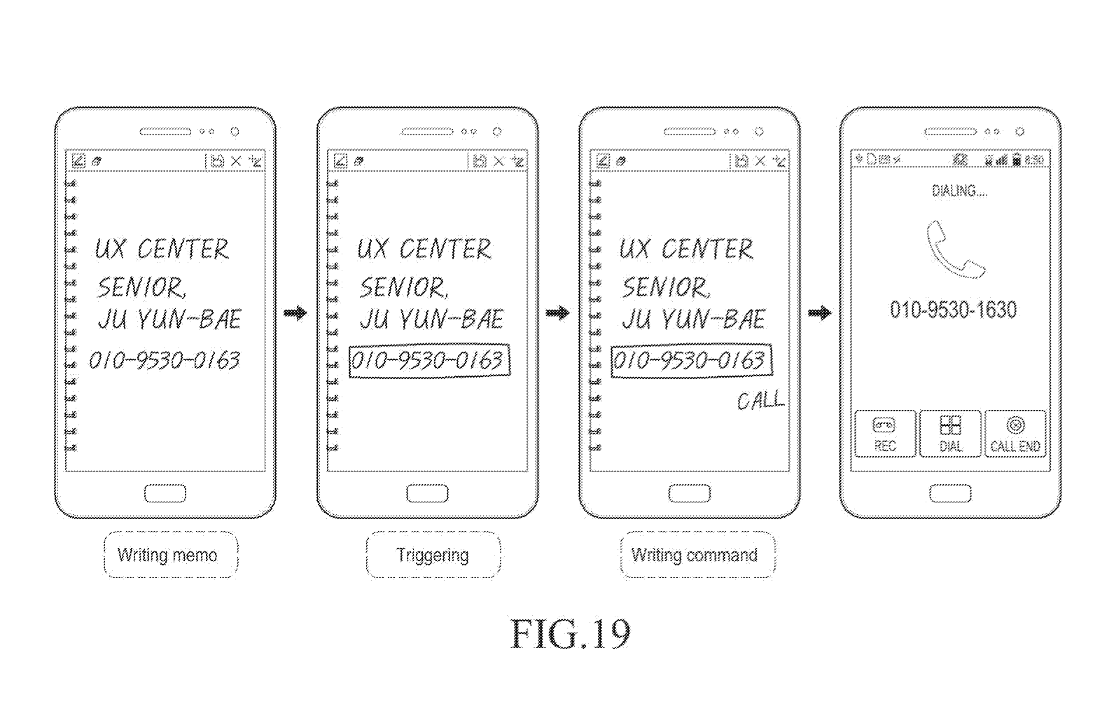

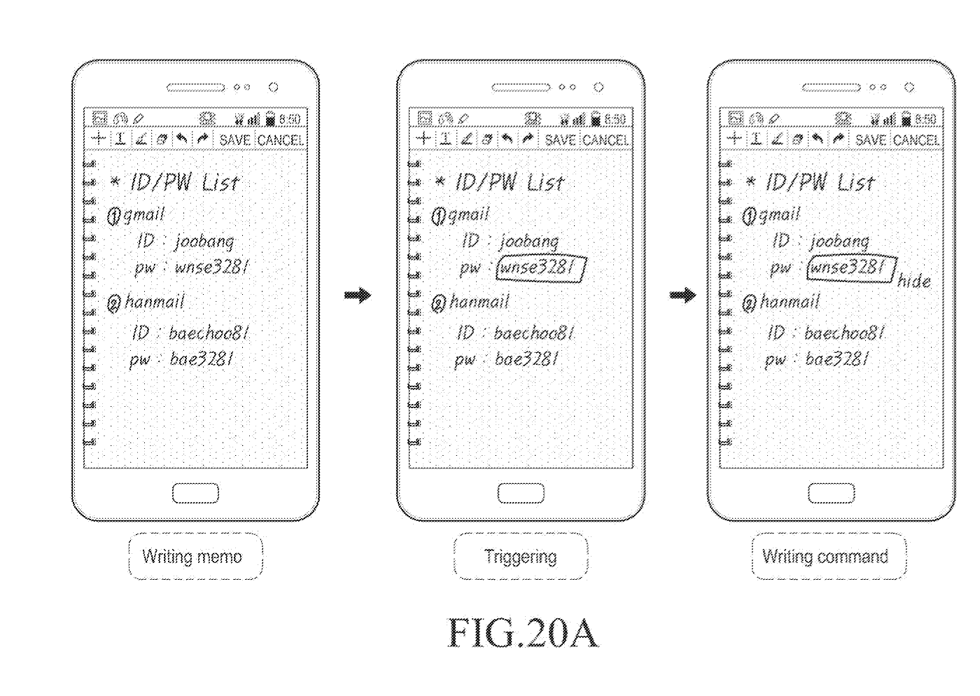

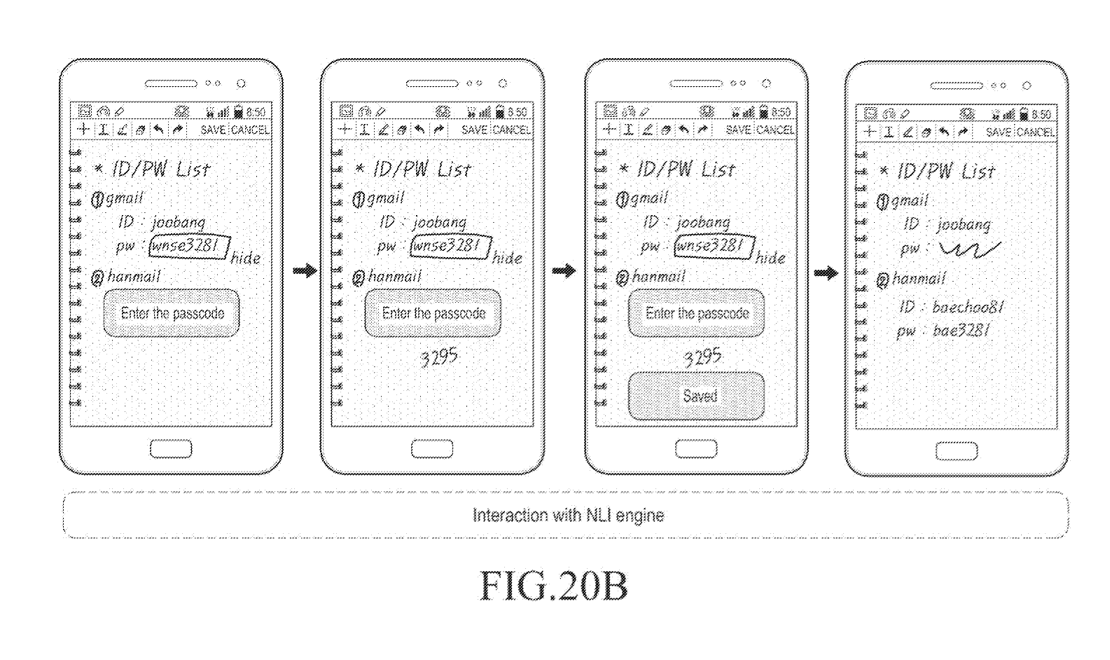

FIGS. 20A and 20B illustrate a scenario of hiding a part of a note written down by the memo function at the user terminal.

Referring to FIG. 20A, the user writes down an ID and a password for each Web site that the user visits on a screen of the user terminal by the memo function (e.g., Writing memo). Then the user selects a part of the note using a line, symbol, closed loop, and the like (e.g., Triggering). For example, the user may select a password ‘wnse3281’ in a part of the note by drawing a closed loop around the password.

The user requests hiding of the selected content by writing down preset or intuitively recognizable text, for example, ‘hide’ (e.g., Writing command).

The NLI engine that configures a UI based on user-input information recognizes that the user intends to hide the selected note content.

Referring to FIG. 20B, to use a hiding function, the NLI engine further acquires necessary information from the user by a question and answer procedure, determining that additional information is needed (e.g., Interaction with NLI engine). The NLI engine outputs a question asking the password, for example, a message ‘Enter the password’ to set the hiding function.

When the user writes down ‘3295’ as the password by the memo function as an answer to set the hiding function, the NLI engine recognizes ‘3295’ by translating the password into a natural language and stores ‘3295’. Then the NLI engine hides the selected note content so that the password does not appear on the screen.

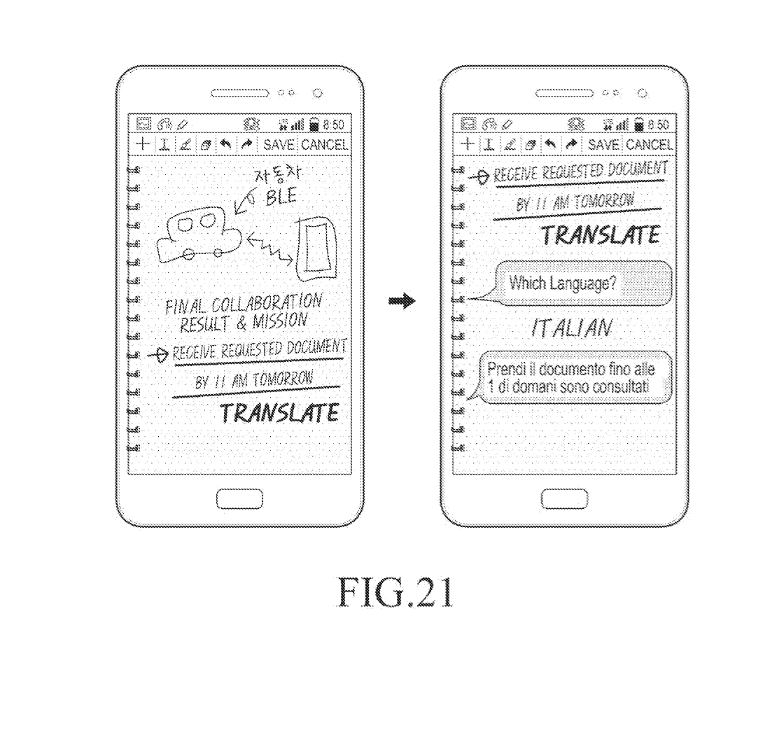

FIG. 21 illustrates a scenario of translating a part of a note written down by the memo function at the user terminal.

Referring to FIG. 21, the user writes down a note on a screen of the user terminal by the memo function (e.g., Writing memo). Then the user selects a part of the note using a line, symbol, closed loop, and the like (e.g., Triggering). For example, the user may select a sentence ‘receive requested document by 11 AM tomorrow’ in a part of the note by underlining the sentence.

The user requests translation of the selected content by writing down preset or intuitively recognizable text, for example, ‘translate’ (e.g., Writing command).

The NLI engine that configures a UI based on user-input information recognizes that the user intends to request translation of the selected note content. Then the NLI engine displays a question asking a language into which the selected note content are to be translated by a question and answer procedure. For example, the NLI engine prompts the user to enter an intended language by displaying a message ‘Which language’ on the screen.

When the user writes down ‘Italian’ as the language by the memo function as an answer, the NLI engine recognizes that ‘Italian’ is the user's intended language. Then the NLI engine translates the recognized note content, that is, the sentence ‘receive requested document by 11 AM tomorrow’ into Italian and outputs the translation. Therefore, the user reads the Italian translation of the requested sentence on the screen.

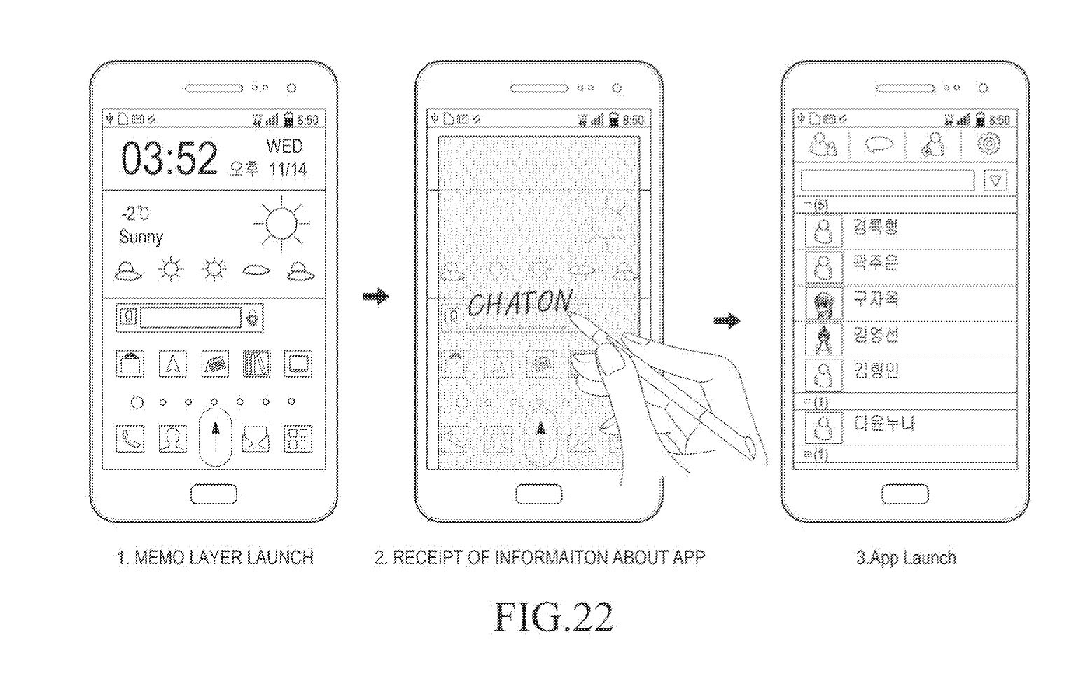

FIGS. 22, 23, 24A and 24B, and 25 illustrate exemplary scenarios of launching an application supporting a memo function after a specific application is activated and then executing an activated application by the launched application according to an embodiment of the present disclosure.

FIG. 22 illustrates a scenario of executing a memo layer on a home screen of the user terminal and executing a specific application on the memo layer. For example, the user terminal launches a memo layer on the home screen by executing a memo application on the home screen and executes an application, upon receipt of identification information about the application (e.g., the name of the application) ‘Chaton’.

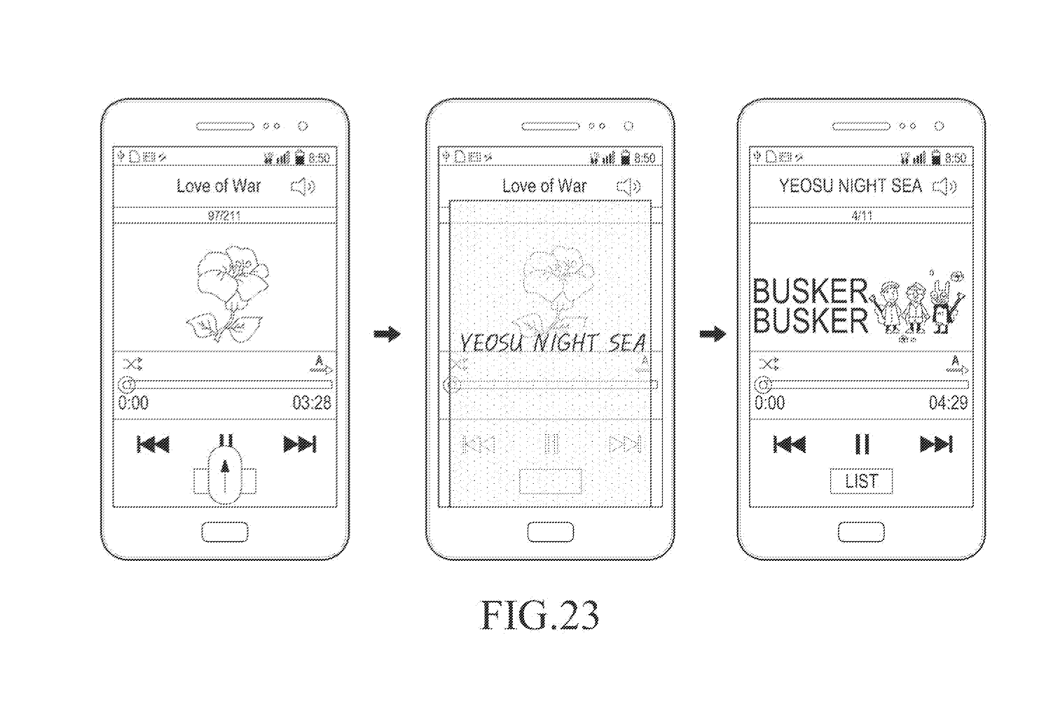

FIG. 23 illustrates a scenario of controlling a specific operation in a specific active application by the memo function at the user terminal. For example, a memo layer is launched by executing a memo application on a screen on which a music play application has already been executed. Then, when the user writes down the title of an intended song, ‘Yeosu Night Sea” on the screen, the user terminal plays a sound source corresponding to ‘Yeosu Night Sea” in the active application.

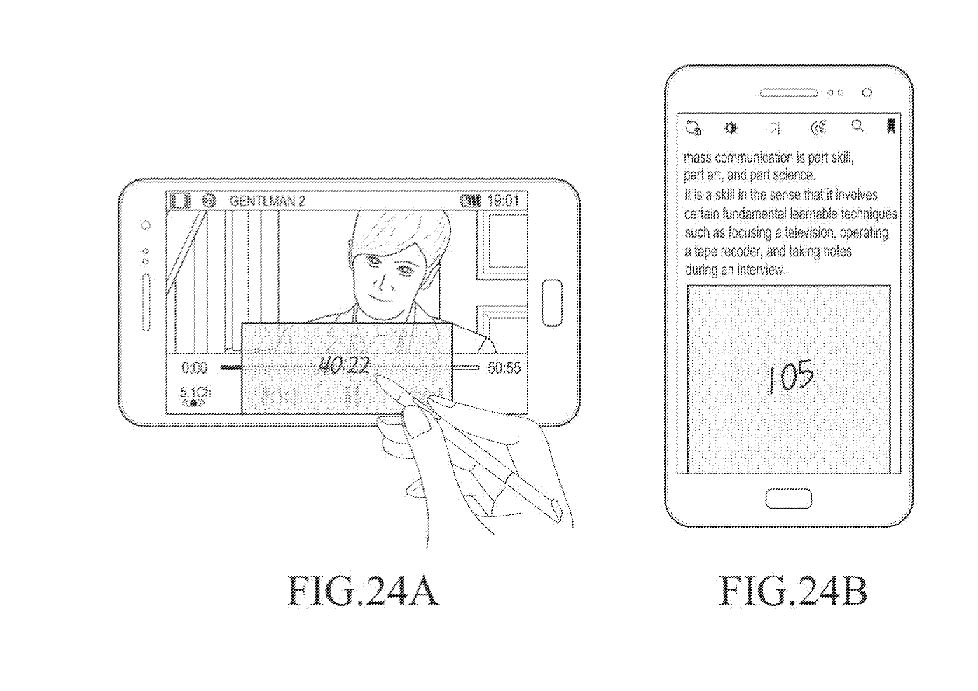

FIG. 24A illustrates exemplary scenarios of controlling a specific active application by the memo function at the user terminal. For example, if the user writes down a time to jump to, ‘40:22’ on a memo layer during viewing a video, the user terminal jumps to a time point of 40 minutes 22 seconds to play the on-going video. This function may be performed in the same manner during listening to music as well as during viewing a video.

FIG. 24B illustrates exemplary scenarios of controlling a specific active application by the memo function at the user terminal. For example, if the user writes down a page number ‘105’ on a memo layer during reading a document (e.g., in an e-reader application, or the like), the user terminal jumps to a page 105 of the document (or file) being viewed.

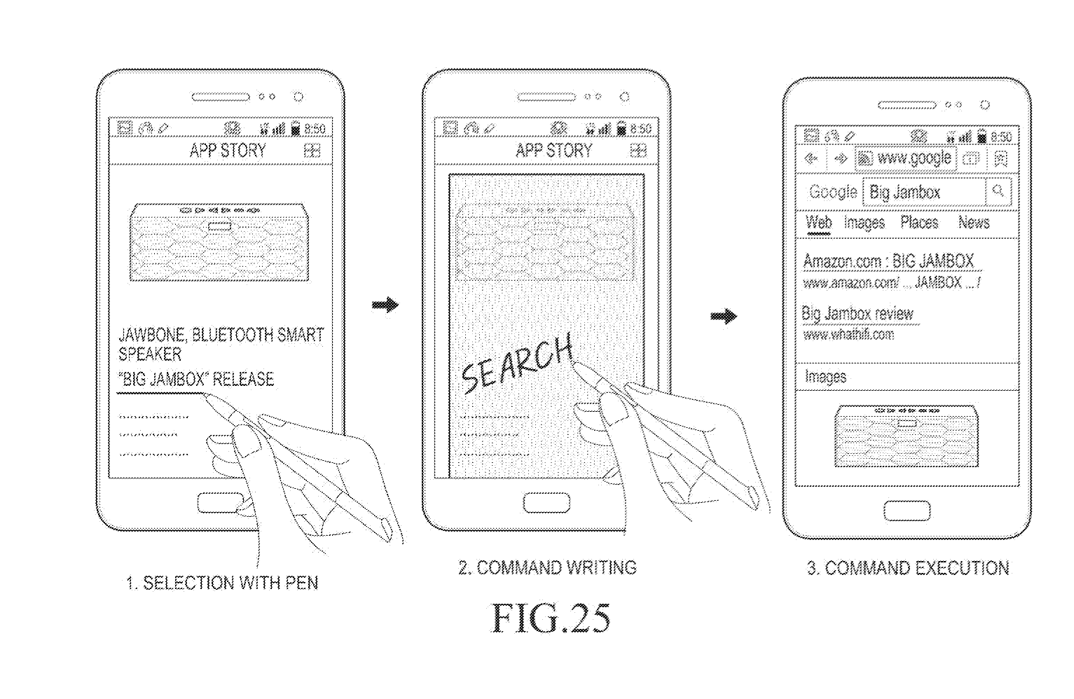

FIG. 25 illustrates a scenario of attempting a search using the memo function, while a Web browser is being executed at the user terminal. For example, while reading a specific Web page using a Web browser, the user selects a part of content displayed on a screen, launches a memo layer, and then writes down a word ‘search’ on the memo layer, thereby commanding a search using the selected content as a keyword. The NLI engine recognizes the user's intention and understands the selected content through a natural language process. Then the NLI engine searches using a set search engine using the selected content and displays search results on the screen.

As described above, the user terminal may process selection and memo function-based information input together on a screen that provides a specific application.

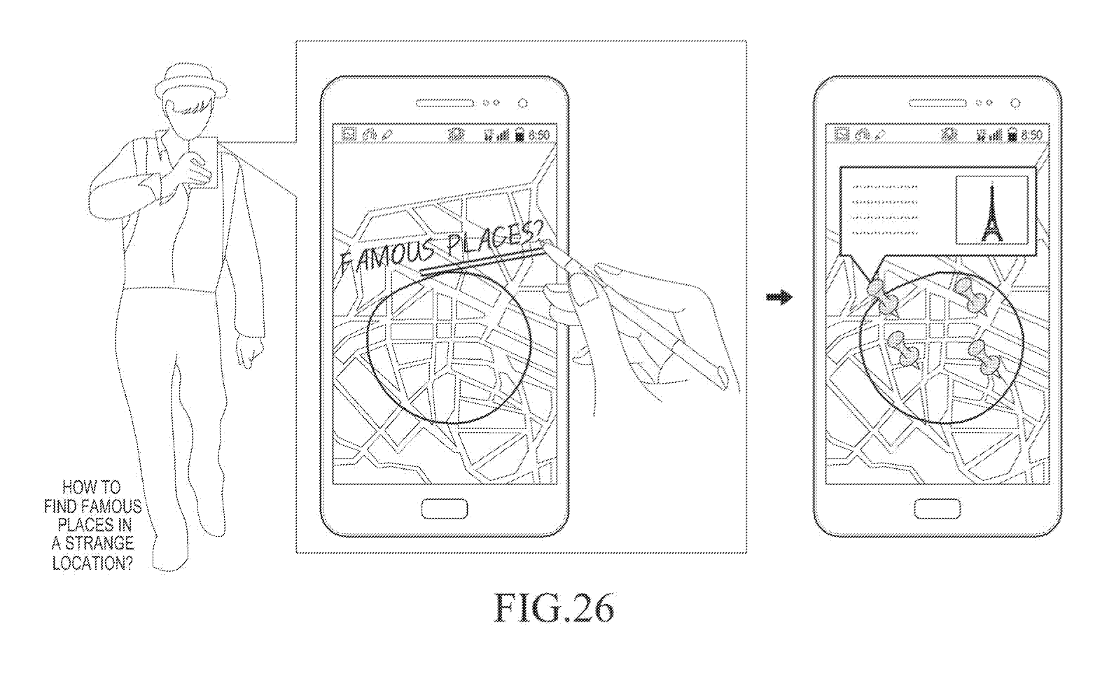

FIG. 26 illustrates a scenario of acquiring intended information in a map application by a memo function according to an embodiment of the present disclosure.

Referring to FIG. 26, as an example, the user selects a specific area by drawing a closed loop around the area on a screen of a map application using the memo function and writes down information to search for, for example, ‘famous place?’, thereby commanding search for famous places within the selected area.

When recognizing the user's intention, the NLI engine searches for useful information in a preserved database (e.g., stored locally on the user terminal) or a database of a server and additionally displays detected information on the map displayed on the current screen.

The map application-related scenarios will be described in greater detail.

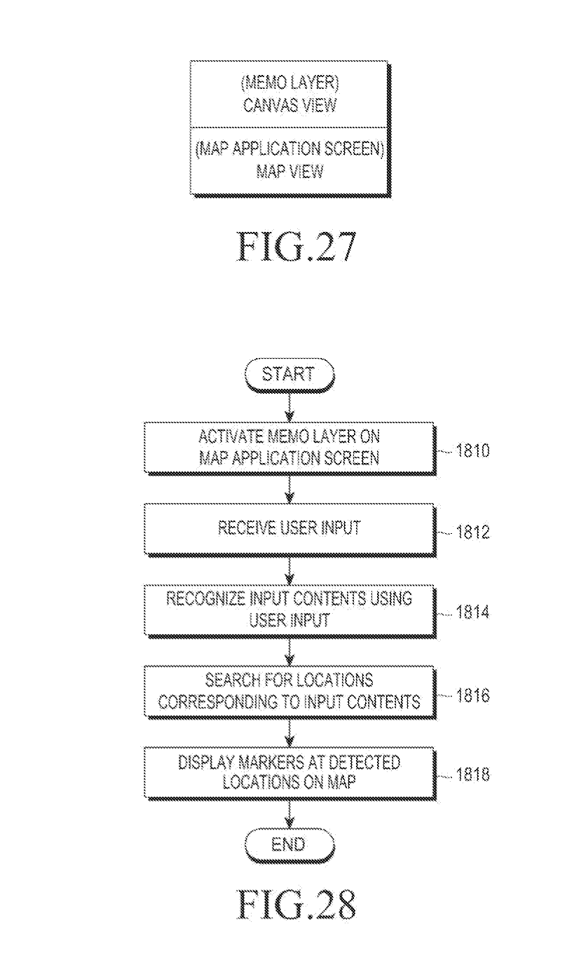

FIG. 27 illustrates activation of a memo function in a map application according to an embodiment of the present disclosure.

Referring to FIG. 27, the touch panel unit 130 may drive the display panel 132, the touch panel 134, and the pen recognition panel 136, activate a map view to display an application screen on the display panel 132, and activate a canvas view to activate the memo function through the touch panel 134 and the pen recognition panel 136. The canvas view may include an S canvas view for displaying a recognized pen input and an NLIS view for NLI processing and displaying.

FIGS. 28, 29, 30, 31, and 32 illustrate methods for providing a memo-based UI in a map application according to embodiments of the present disclosure.

FIG. 28 is a flowchart illustrating a control operation for indicating detected locations on a map in the map application according to an embodiment of the present disclosure.

Referring to FIG. 28, the user terminal 100 activates a memo layer on a screen of the map application upon user request during executing the map application at operation 1810. The memo layer may be a transparent or semi-transparent screen that is not displayed as a separate screen. It is assumed herein that the memo layer is not displayed as a separate screen. The user may apply a user input through handwriting (e.g., a first-type input) or a user input drawing (e.g., a second-type input) by means of the touch pen 20, an object (not shown) such as a finger, or the like. Handwriting refers to writing text, a symbol, and the like, and drawing refers to creating a figure, a scribble, a closed loop, and the like.

The user terminal 100 receives the user input according to a touch of the object such as a finger (or the like) or a manipulation of the touch pen 20 at operation 1812. The user terminal 100 may receive a touch input according to the touch of the object such as a finger or a pen input according to the pen manipulation. An embodiment of the present disclosure will be described in the context of reception of a pen input event by a pen function, by way of example.

At operation 1814, the user terminal 100 recognizes the pen input using the pen input event triggered by the pen function and recognizes the content of the pen input using pen input recognition information. For example, the user terminal 100 recognizes a first-type input (e.g., a handwriting input) or a second-type input (e.g., a drawing input).

In the case of a handwriting input as a result of recognizing the input content, the user terminal 100 searches for locations corresponding to the input content at operation 1816. The user terminal 100 may acquire at least location information according to the handwriting input.

Subsequently, the user terminal 100 displays at least location information such as markers at the detected locations on a map according to search results at operation 1818.

In another embodiment of the present disclosure, detected locations included in a specific selected area may be marked on the map.

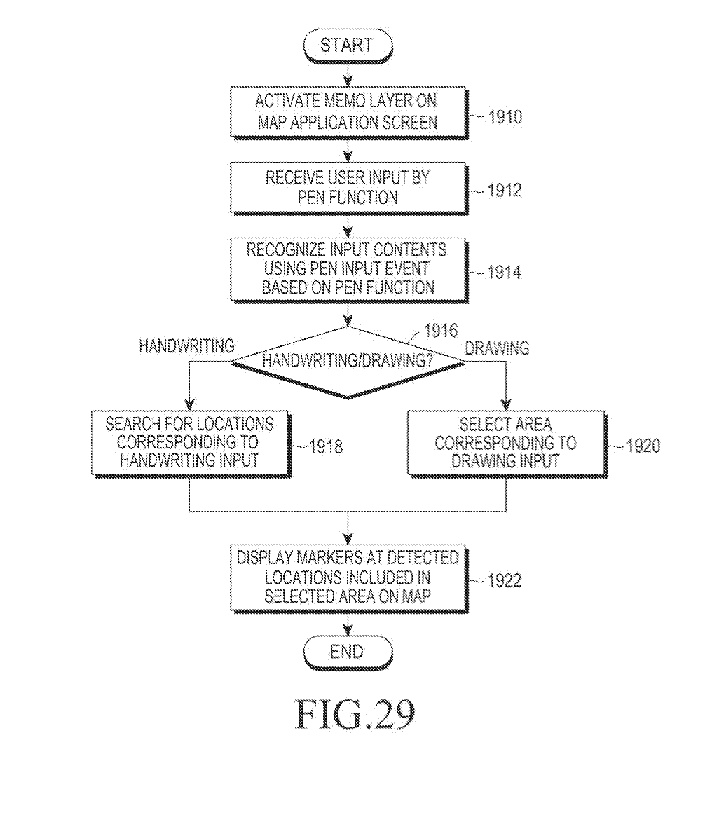

FIG. 29 is a flowchart illustrating a control operation for marking detected locations within a specific selected area of the map in the map application according to an embodiment of the present disclosure.

Referring to FIG. 29, the user terminal 100 activates the memo layer on the screen of the map application upon user request during executing the map application at operation 1910. The memo layer may be a transparent or semi-transparent screen that is not displayed as a separate screen. It is assumed herein that the memo layer is not displayed as a separate screen.

The user may apply a user input through handwriting or drawing by means of the touch pen 20, an object (not shown) such as a finger, or the like. In the embodiment of the present disclosure, the user inputs information with the touch pen 20, by way of example.

The user terminal 100 receives the user input by the pen function according to a user's manipulation of the touch pen 20, for example, according to a user's handwriting or drawing at operation 1912. Herein, the touch panel unit 130 may generate a pen input event by the pen function and output the pen input event.

The memo layer may be divided into first and second areas and the touch panel unit 130 may generate and output pen input events according to the first and second areas. For example, upon generation of a pen input in the first area of the memo layer, the touch panel unit 130 may output a first input event corresponding to a pen input event from the first area. Upon generation of a pen input in the second area of the memo layer, the touch panel unit 130 may output a second input event corresponding to a pen input event from the second area.

The user terminal 100 acquires pen input recognition information using the pen input event based on the pen function and recognizes the content of the input at operation 1914. For example, the user terminal 100 recognizes a handwriting input or a drawing input.

The user terminal 100 may perform pen input recognition using the first type input from the first area and may recognize the input as a handwriting input. In addition, the user terminal 100 may perform pen input recognition using the second type input from the second area and may recognize the input as a drawing input. It may be further contemplated as another embodiment of the present disclosure that if each pen input recognition information of the first and second type input in the first and second areas corresponds to a handwritten form, the user terminal 100 may recognize an input as a handwriting input, and if the pen input recognition information corresponds to a drawn form, the user terminal 100 may recognize the input as a drawing input.

The user terminal 100 determines whether the input is a handwriting input or a drawing input as a result of recognizing input content at operation 1916. Specifically, the user terminal 100 may recognize an input to the first area as a handwriting input and an input to the second area as a drawing input. In addition, the user terminal 100 determines strokes according to the input content. If the strokes correspond to handwriting, the user terminal 100 may recognize the input content as a handwriting input, and if the strokes correspond to drawing, the user terminal 100 may recognize the input content as a drawing input. The user terminal 100 may determine a drawing object according to the recognized input content as a drawing input.

The drawing object may be a closed loop covering a specific area, such as a concentric circle, an oval, and the like. Upon recognizing a handwriting input, the user terminal 100 searches for locations corresponding to the handwriting input at operation 1918. The locations may be detected using a map Application Programming Interface (API) and a location search API.

Upon recognizing a drawing input, the user terminal 100 selects a drawing object area corresponding to the recognized content of the drawing input on the map at operation 1920. For example, if the drawing object is a concentric circle, the user terminal 100 detects the uppermost and lowermost points of the concentric circle by comparing the coordinates of the drawn circle, calculates the center and radius based on the intersection between the uppermost and lowermost points, and displays a concentric circular area having the radius on the map view. The concentric circular area may be calculated as follows.

```
  CanvasPoint leftPoint = stroke.get(0);
  *227CanvasPoint rightPoint = stroke.get(0);
  CanvasPoint upPoint = stroke.get(0);
  CanvasPoint downPoint = stroke.get(0);
  for (CanvasPoint p : stroke)
  if (p.getX( ) < leftPoint.getX( ))
  leftPoint = p;
  else if (p.getX( ) > rightPoint.getX( ))
  rightPoint = p;
  else if (p.getY( ) < downPoint.getY( ))
  downPoint = p;
  else if (p.getY( ) > upPoint.getY( ))
  upPoint = p;
  }
  }
  CanvasPoint centerPoint = getIntersectionPoint(leftPoint,
rightPoint, upPoint, downPoint);
  if (centerPoint == null)
  return null;
  int radius = getRadius(leftPoint, rightPoint, upPoint,
downPoint, centerPoint);
  if (radius < CONSTRAINT_MINIMUN_DOMAIN_RADIUS_SIZE)
  return null;
  return new SimpleCircle(centerPoint, radius).
```

Then the user terminal 100 generates an overlay view to be displayed over the map view and displays markers at the detected locations within the selected area such as drawing object area on the map through the overlap view at operation 1922.

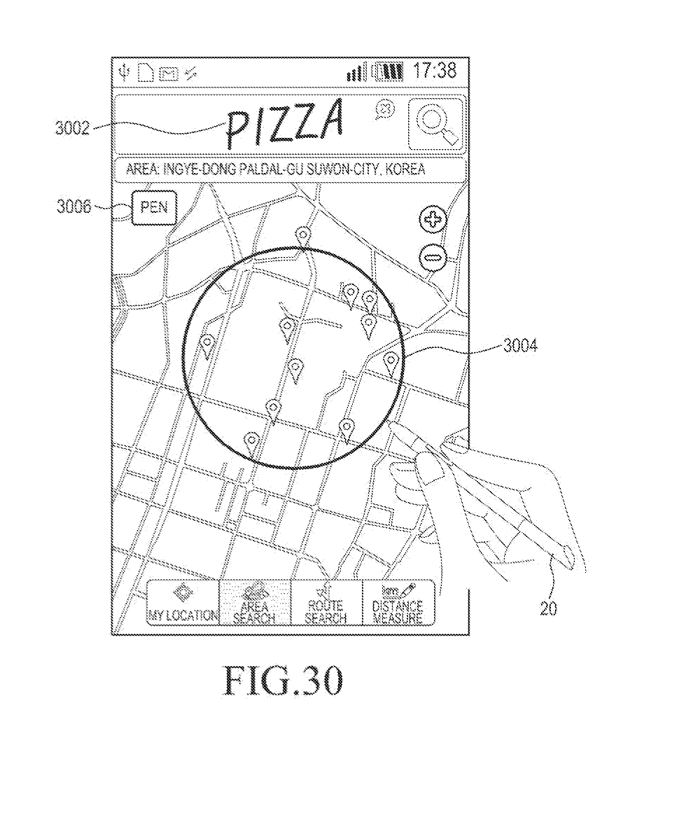

FIG. 30 illustrates a screen that displays detected locations only within a specific selected area on the map according to an embodiment of the present disclosure. The user writes down “pizza” 3002 and draws a concentric circle 3004 with the touch pen 20. Then the user terminal 100 searches for locations related to pizza within the drawing object area such as the concentric circular area of the map and displays marks at the detected locations. An indication 3006 indicating pen mode (e.g., indicating that the pen mode has been activated) may further be displayed.

The selected area may be shifted.

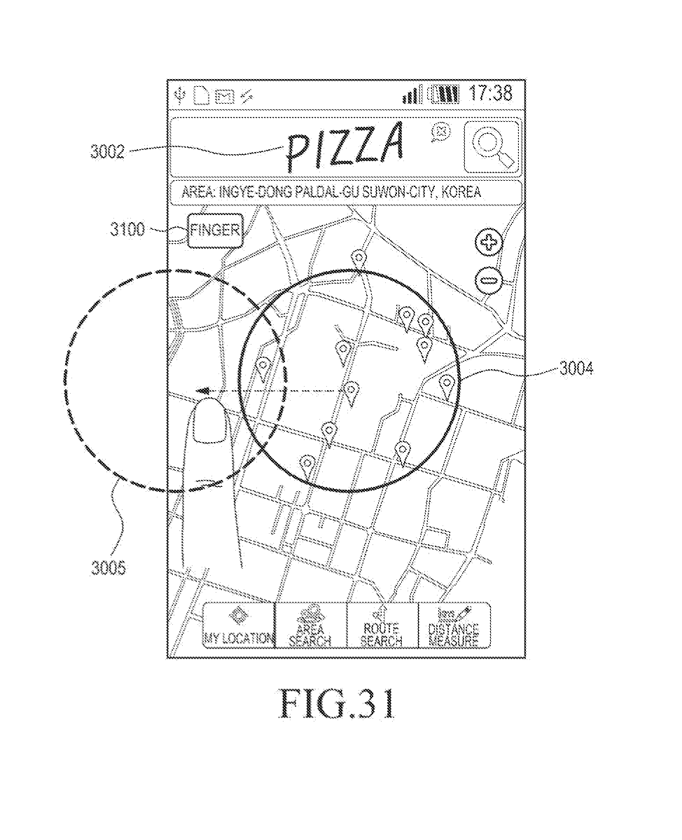

FIG. 31 illustrates shifting a selected area on the map according to an embodiment of the present disclosure.

Referring to FIG. 31, when the pen mode is changed to finger mode (e.g., hand touch mode), as indicated by reference numeral 3100, the user may shift the drawing object according third type input by user in the hand touch mode, thus shifting the drawing object area 3004. Therefore, markers (or location information) (e.g., corresponding to a search for the string “pizza” 3002) may be displayed within a shifted drawing object area 3005.

In embodiment of the present disclosure, the user terminal 100 may transmit the handwriting information and the drawing object area information to a server, and receive from the server, information about an area corresponding to the drawing object area information and information about at least location information included in the area according to the handwriting information.

In another embodiment of the present disclosure, the user terminal 100 may transmit the handwriting information and the information about a range of the map to a server, and receive, from the server, information about at least location information included in the range of the map according to the handwriting information.

Meanwhile, the user terminal 100 may recognize an additional drawing input, acquire information about an additional drawing object area according to the additional drawing input, and display, within a range of the map, at least location information included in the additional drawing object area according to the handwriting information.

While it has been described that a UI of the present disclosure is used to indicate detected locations on a map, the UI may also be used for distance measurement on the map.

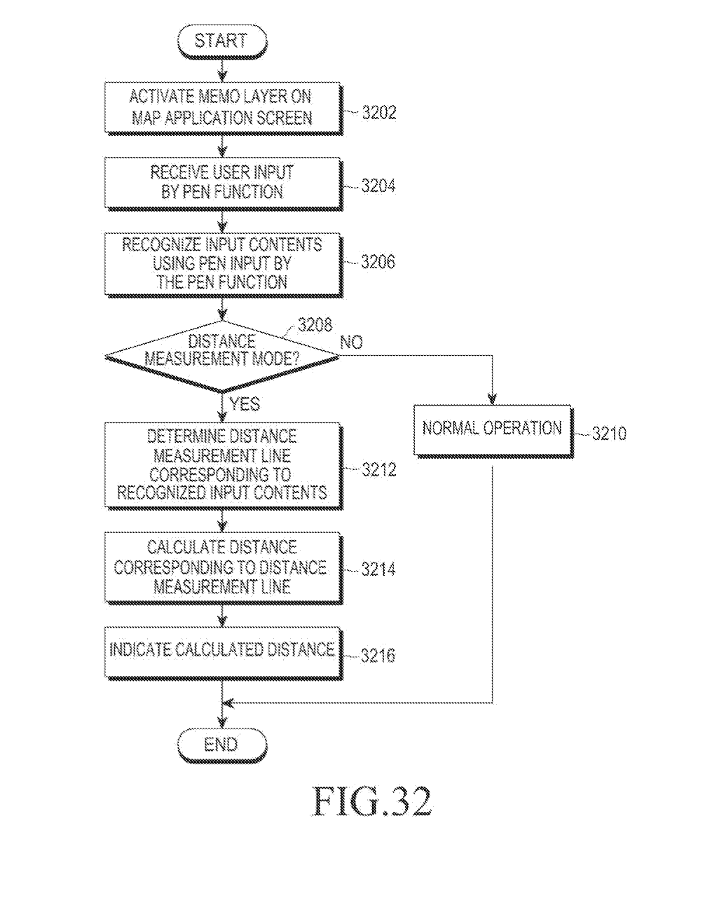

FIG. 32 is a flowchart illustrating a control operation for measuring a distance on a map in a map application according to an embodiment of the present disclosure.

Referring to FIG. 32, the user terminal 100 activates the memo layer on the screen of the map application upon user request during executing the map application at operation 3202. The memo layer may be a transparent or semi-transparent screen that is not displayed as a separate screen. It is assumed herein that the memo layer is not displayed as a separate screen. The user may apply a user input through handwriting or drawing by means of the touch pen 20.

The user terminal 100 receives the user input according to a manipulation of the touch pen 20 at operation 3204. Thus a pen input event may occur by the pen function.

The user terminal 100 recognizes the content of the pen input using the pen input event triggered by the pen function at operation 3206. For example, the user terminal 100 recognizes a handwriting input or a drawing input.

The user terminal 100 determines whether the current mode is distance measurement mode at operation 3208.

If the current mode is not the distance measurement mode, the user terminal 100 performs a function corresponding to the recognized input content at operation 3210.

If the current mode is the distance measurement mode, the user terminal 100 determines a distance measurement line corresponding to the recognized input content at operation 3212. If the user draws a line without detaching the touch pen 20 from a touch starting point to a touch ending point, the user terminal 100 may determine the line as a distance measurement line.

Upon receipt of the distance measurement line, the user terminal 100 calculates a distance corresponding to the distance measurement line at operation 3214 and indicates the calculated distance at operation 3216. As the line is drawn, distances may be indicated all the way along with the progress of the line.

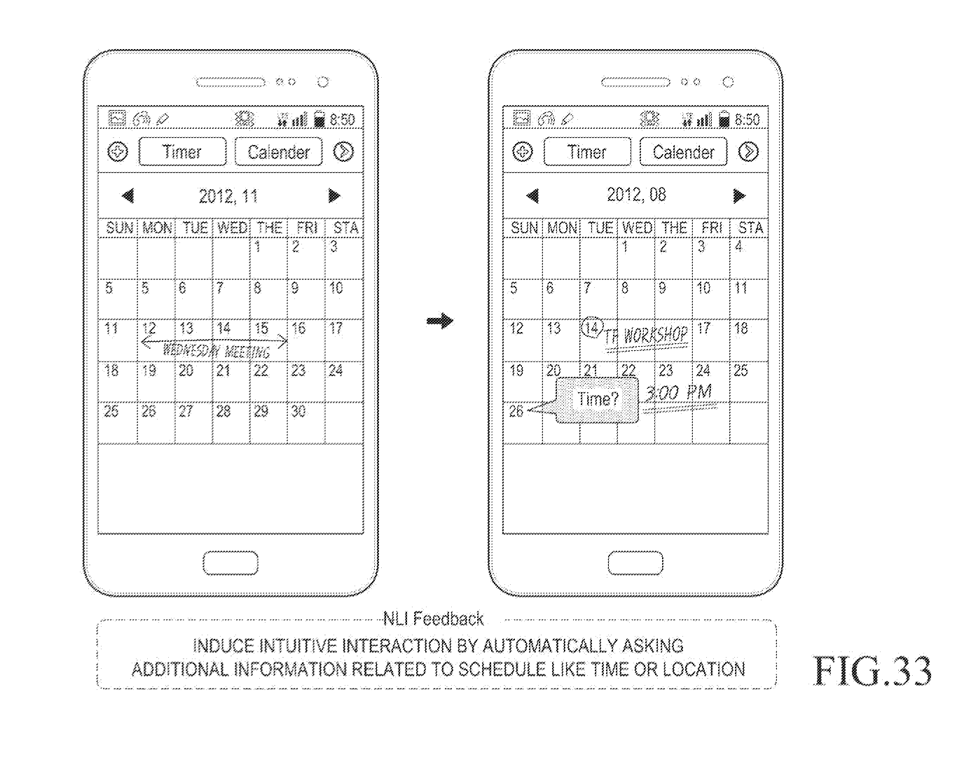

FIG. 33 illustrates a scenario of inputting intended information by a memo function, while a schedule application is activated according to an embodiment of the present disclosure.

Referring to FIG. 33, as an example, while the schedule application is being activated, the user executes the memo function and writes down information on a screen, as is done offline intuitively. For instance, the user selects a specific date by drawing a closed loop on the schedule screen and writes down a plan for the date. For example, the user selects Aug. 14, 2012 and writes down ‘TF workshop’ for the date. Then the NLI engine of the user terminal 100 requests input of time as additional information. For example, the NLI engine displays a question ‘Time?’ on the screen so as to prompt the user to enter an accurate time such as ‘3:00 PM’ by the memo function.

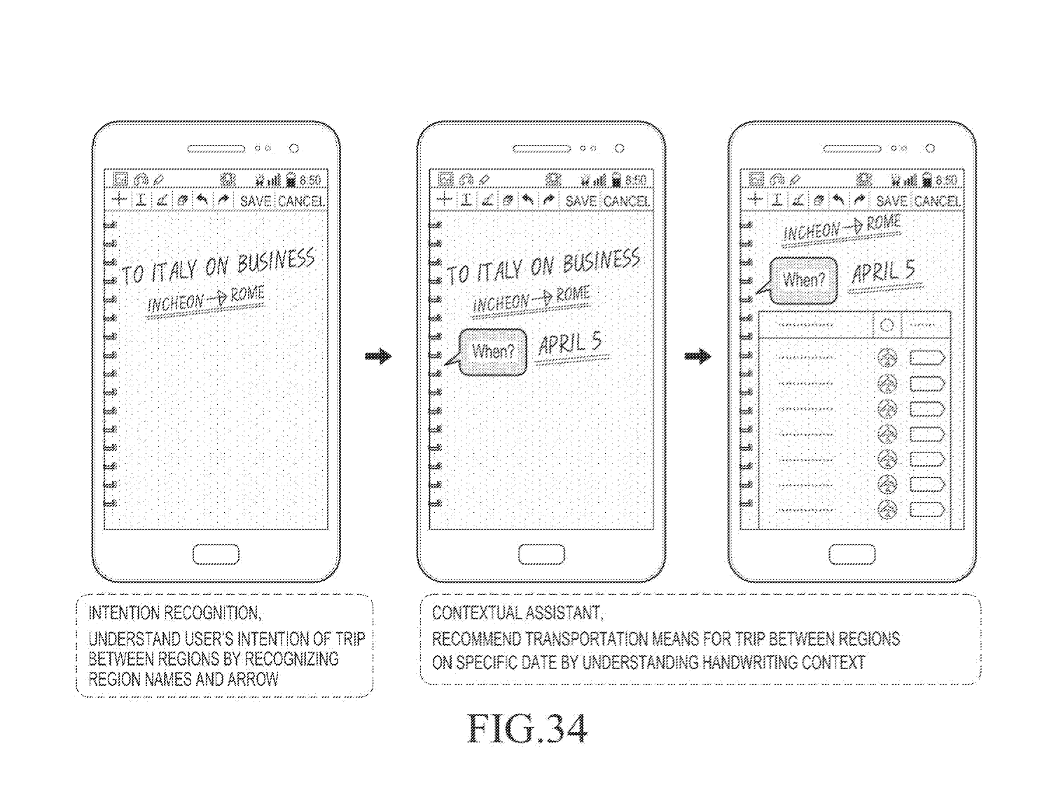

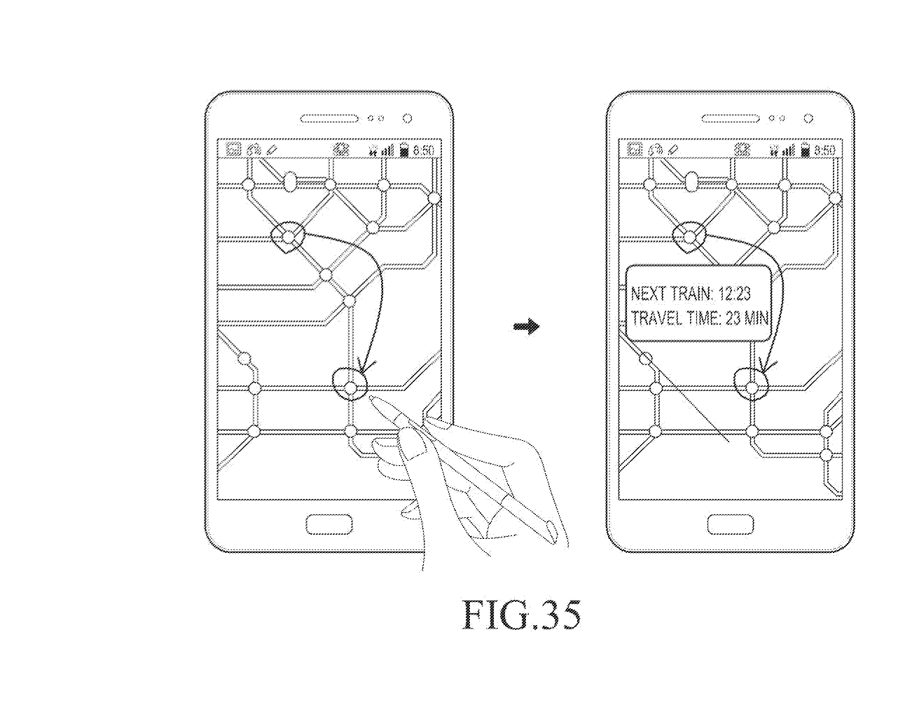

FIGS. 34 and 35 illustrate scenarios related to semiotics according to an embodiment of the present disclosure.

FIG. 34 illustrates interpreting a meaning of a handwritten symbol in a context of a question and answer flow made by a memo function.

Referring to FIG. 34, as an example, it may be assumed that both notes ‘to Italy on business’ and ‘Incheon→Rome’ are written. Because the symbol → may be interpreted as trip from one place to another, the NLI engine of the user terminal 100 outputs a question asking time, for example, ‘When?’ to the user.

Further, the NLI engine may search for information about flights (or other modes of transportation and travel information such as, for example, hotel and/or rental car availability) available for the trip from Incheon to Rome on a user-written date, April 5 and provide search results to the user.

FIG. 35 illustrates interpreting a meaning of a symbol written by a memo function in conjunction with an activated application.

Referring to FIG. 35, as an example, when the user selects a departure and a destination using a symbol (e.g., an arrow) in an intuitive manner on a screen on which a subway application is being activated, the user terminal 100 may recognize the selection. Then the user terminal 100 may provide information about the arrival time of a train heading for the destination and a time taken to reach the destination by the currently activated application.

As described above, various embodiments of the present disclosure can increase user convenience by supporting a memo function in various applications and thus controlling the applications in an intuitive manner.

The above-described scenarios are characterized in that when a user launches a memo layer on a screen and writes down information on the memo layer, the user terminal recognizes the information and performs an operation corresponding to the information. For this purpose, it will be preferred to additionally specify a technique for launching a memo layer on a screen.

For example, the memo layer may be launched on a current screen by pressing a menu button, inputting a specific gesture, keeping a button of a touch pen pressed, or scrolling up or down the screen by a finger. However, many other techniques are available.

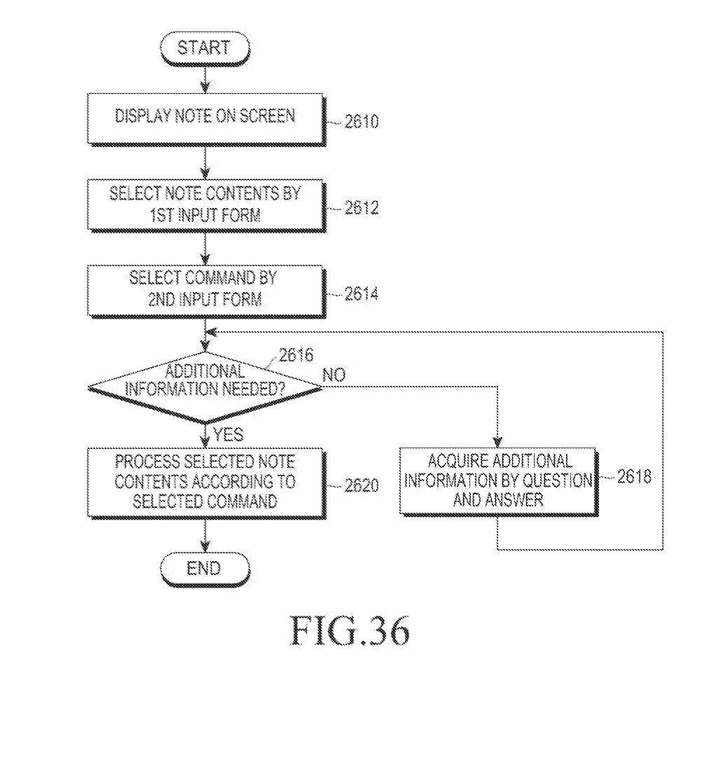

FIG. 36 is a flowchart illustrating a control operation for providing a memo-based UI in a user terminal according to an embodiment of the present disclosure.

Referring to FIG. 36, the whole or a part of a note written down on a screen of the user terminal is selected by means of a predetermined input form and thus the selected partial or whole content of the note are recognized as one of information to be processed and a command to be executed.

For this purpose, operations for recognizing note content, identifying a command, and processing the recognized note content according to a function corresponding to the identified command are defined separately in FIG. 36. For example, the whole or a part of a note displayed on a screen is recognized based on a preset input form, a command for processing the selected note content is identified from the displayed note content based on another preset input form, and the recognized note content are processed by a function menu corresponding to the identified command. The input form with which to recognize the note contents should be distinguished from the input form with which to identify the command.

Referring to FIG. 36, upon user request, the user terminal displays specific note content on a screen at operation 2610. The user may input the note content on the screen in real time by the memo function or may retrieve one of preliminarily written notes.

The user terminal selects the whole or a part of the displayed note content based on a first input form at operation 2612.

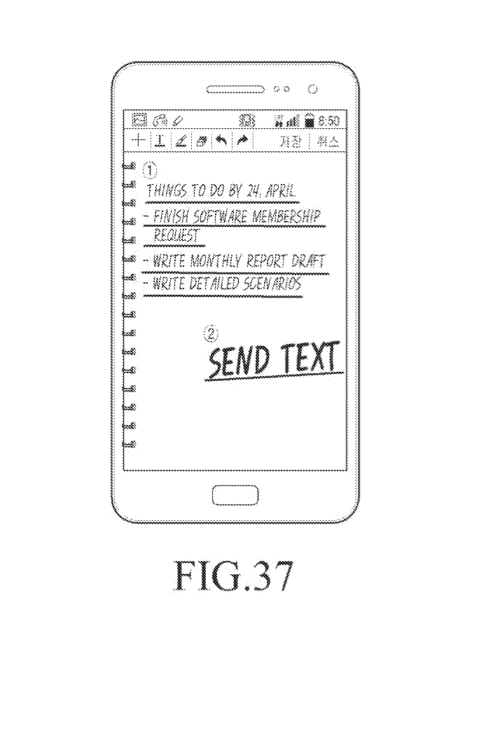

FIG. 37 illustrates an example of distinguishing usages of note content in a user terminal according to an embodiment of the present disclosure.

Referring to FIG. 37, exemplary note contents selected using the first input form are indicated by ‘circled number 1 (\textcircled{1})’. Similarly, the second input form may be indicated by ‘circled number 2’ (e.g., the written command ‘send text’ may be indicated by the ‘circled number 2’).

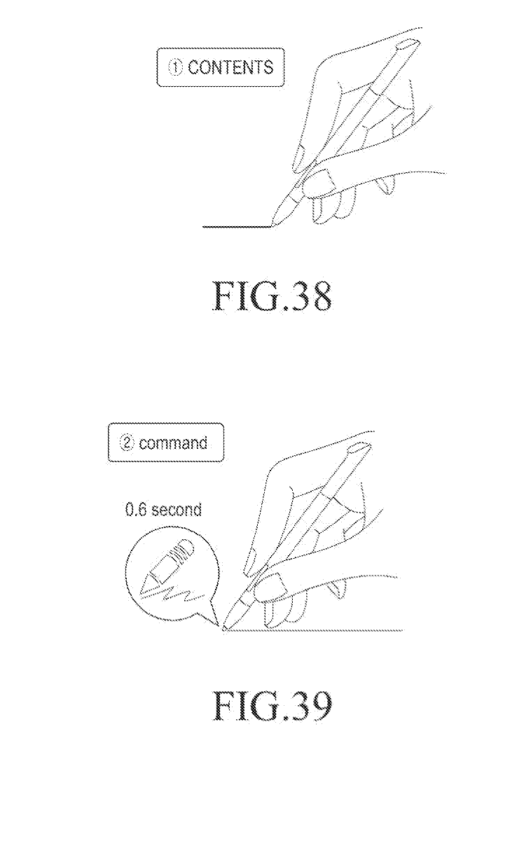

FIG. 38 illustrates an exemplary first input form to select note content according to an embodiment of the present disclosure.

Referring to FIG. 38, underlining note content using an electronic pen is proposed as an example of the first input form. In this case, when the user underlines the whole or a part of note content displayed on a screen, the user terminal recognizes the underlined note content as note contents to be processed. For example, the user terminal converts the underlined note content into a natural language and recognizes the selected whole or part note content from the converted natural language.

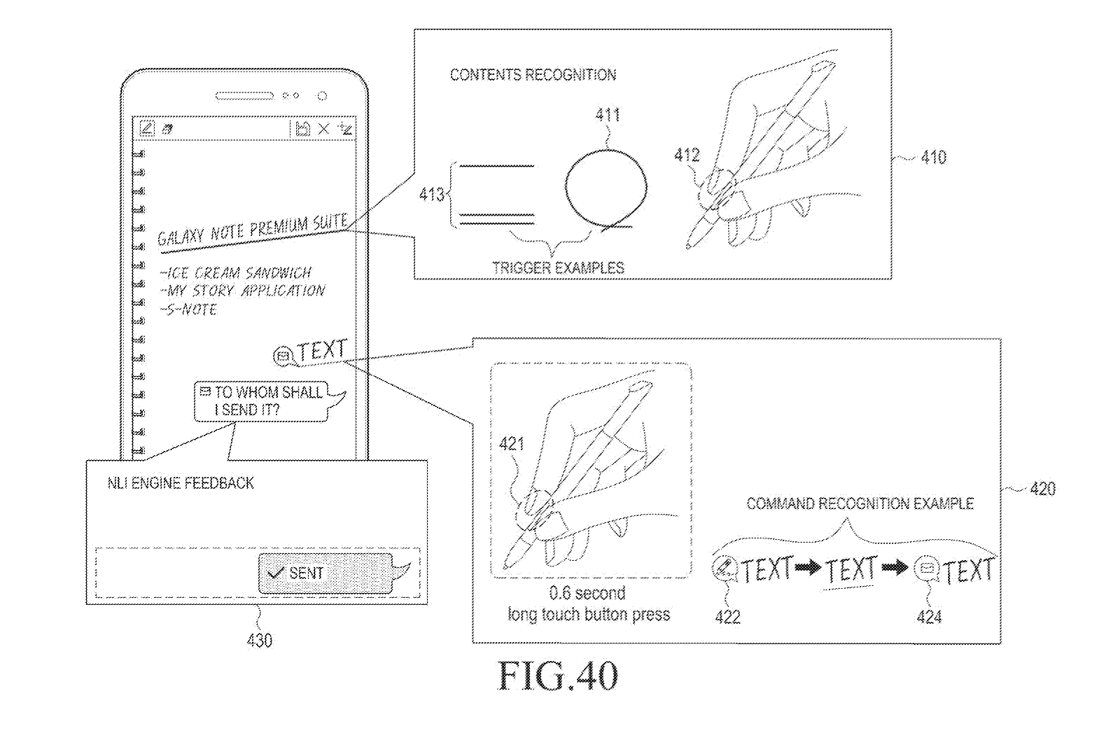

Other examples of the first input form are illustrated in FIG. 40.

FIG. 40 illustrates an example of performing an operation as intended by a user based on a memo function in a user terminal according to an embodiment of the present disclosure.

Referring to FIG. 40, at operation 410, when the user selects an area of note content by drawing a circle at operation 411 or the user writes a note by pressing a button at operation 412 of the electronic pen once or while keeping the button at operation 412 pressed, the user terminal recognizes the selected area or the written note as selected note content. When the user writes a note in real time or when the user underlines at operation 413 the whole or a part of a note after setting content recognition mode through a menu, the user terminal may select the real-time written note or the underlined note.

The user terminal selects a part of the displayed note content based on a second input form at operation 2614. In FIG. 37, exemplary note content selected by the second input form are indicated by ‘circled number 2 (\textcircled{2})’.

FIG. 39 illustrates an example of selecting a command to be executed in a user terminal according to an embodiment of the present disclosure.

Referring to FIG. 39 an exemplary second input form is illustrated. FIG. 39 illustrates an exemplary input form to select a command.

Referring to FIG. 39, keeping the electronic pen touched at the start of intended note content for a predetermined time (e.g., 0.6 seconds) and then underlining the note content is proposed as an example of the second input form. In this case, the user terminal recognizes the note content underlined according to the second input form among the displayed note content as a command requesting execution of a specific function menu. For example, the user terminal converts note content underlined according to the second input form into a natural language and recognizes the converted natural language as a user-intended command.

Examples of the second input form are illustrated in FIG. 40. At operation 420 of FIG. 40, writing note content corresponding to an intended command to be executed after the button of the electronic pen is pressed once or while the button of the electronic pen is kept pressed at operation 421, or writing a note in real time or selecting intended note content among displayed note content after command recognition mode is set by a menu are provided as exemplary second input forms.

Referring to operation 420 of FIG. 40, upon sensing a preliminary gesture indicating the second input form before underlining, at operation 422, the user terminal displays an icon indicating a command recognition state. Then when the user underlines note content corresponding to a command and the user terminal normally recognizes the underlined note content as a command to be executed, at operation 424, the user terminal changes the icon displayed at operation 422 indicating the command recognition state to an icon indicating a recognized command identifying state.

At operation 2616, the user terminal determines whether additional information is needed to execute the command recognized based on the second input form. Specifically, the user terminal determines whether there is sufficient information to process the note content selected by the first input form according to the command recognized by the second input form.

If determining that additional information is needed, the user terminal performs a question and answer procedure to acquire the necessary additional information from the user at operation 2618. The user terminal displays a message prompting the user to input additional information on the screen and receives the additional information from the user in response to the message.

For example, referring to FIG. 40, the user terminal determines that the user intends to send note content ‘galaxy note premium suite’ in ‘text’, based on the note content and command recognized by the first and second input forms. However, due to the absence of information about a recipient to receive the text, the user terminal considers that the recognized user-intended function menu cannot be performed.

Thus, the user terminal outputs a message ‘To whom shall I send it?’ on the screen. When the user writes down the name or phone number of a recipient to receive the text by the memo function, the user terminal recognizes the name or phone number of the recipient as the additional information.

Upon receipt of the additional information from the user, the user terminal determines whether more additional information is required. If more additional information is required, the user terminal repeats the above operation to acquire more additional information.

In contrast, if more additional information is not needed, the user terminal processes the note content recognized by the first input form by executing the function menu corresponding to the command recognized by the second input form at operation 2620. For example, in the illustrated case of FIG. 37, the user terminal sends the note content selected by ‘circled number 1 (\textcircled{1})’ using a text sending function menu according to the ‘send text’ command recognized by ‘circled number 2 (\textcircled{2})’.

After recognizing the command by the second input form, the user terminal may perform an NLI engine feedback defined in 430 of FIG. 40. The NLI engine feedback involves three operations.

First, when the user terminal needs additional information to execute the function menu corresponding to the recognized command, the user terminal outputs a message prompting the user to input the additional information on the screen. Thus, the user terminal induces the user to provide the additional information needed to execute the function menu.

Another operation is that the user terminal executes the function menu corresponding to the command recognized by the second input form and notifies the user on the screen that the note content recognized by the first input form is being processed. Therefore, the user can confirm normal processing of the user-intended command.

The other operation is that the user terminal notifies the user on the screen that the note content recognized by the first input form has been completely processed by executing the function menu corresponding to the command recognized by the second input form. Therefore, the user can confirm normal completion of processing the user-intended command.

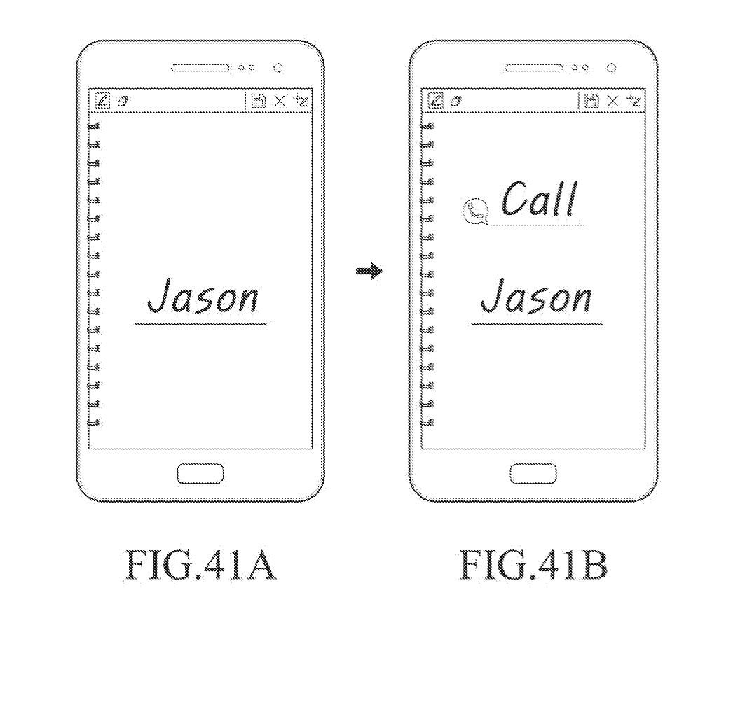

FIGS. 41A and 41B, 42A, 42B, 42C, and 42D, 43A, 43B, 43C, 43D, 43E, 43F, and 43G, 44A and 44B, 45A and 45B, 46A, 46B, 46C, and 46D, and 47A, 47B, and 47C illustrate various command processing procedures according user requests in a user terminal according to various embodiments of the present disclosure.

Specifically, FIGS. 41A and 41B, 42A, 42B, 42C, and 42D, 43A, 43B, 43C, 43D, 43E, 43F, and 43G, 44A and 44B, 45A and 45B, 46A, 46B, 46C, and 46D, and 47A, 47B, and 47C illustrate procedures for executing commands such as ‘call’, ‘send message’, ‘send mail’, ‘post to twit’, ‘post to facebook’, and ‘search information’.

Referring to FIGS. 41A and 41B, the user writes down ‘Jason’ by the memo function supported by the user terminal and then underlines ‘Jason’ (as illustrated in FIG. 41A). Underlining ‘Jason’ corresponds to the first input form. Hence, the user terminal recognizes ‘Jason’ as note content to be processed.

Subsequently, the user writes down ‘Call’ by the memo function and then underlines ‘Call’, making a preliminary gesture preset as the second input form (as illustrated in FIG. 41B). The preset preliminary gesture may be to keep the electronic pen touched in the vicinity of the start of the note ‘Call’ for a predetermined time. Thus, the user terminal recognizes the user's intention to ‘call Jason’ and performs the recognized user-intended operation. The operation includes displaying an icon indicating the recognized command in the vicinity of the note content corresponding to the command.

While the notes corresponding to note contents to be processed and a command to be executed are separately written down in FIGS. 41A and 41B, it may be further contemplated that after the two notes are written down, the note content to be processed are selected by the first input form and the command is selected by the second input form.

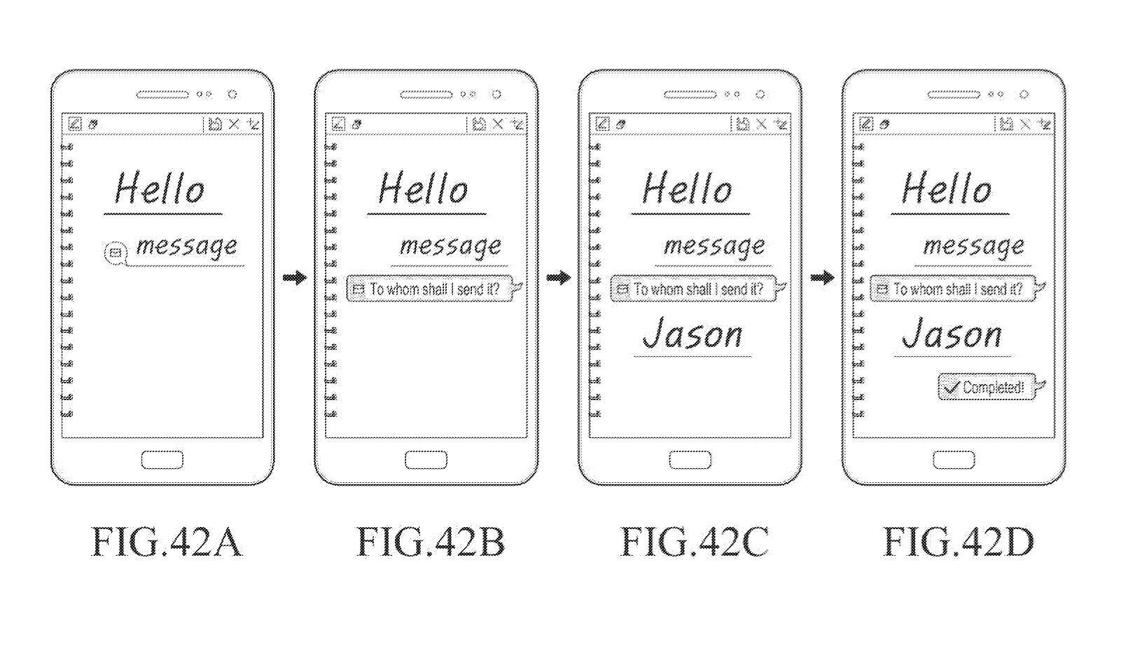

Referring to FIGS. 42A, 42B, 42C, and 42D, the user writes down ‘Hello message’ by the memo function on a screen. Then the user selects ‘Hello’ by the first input form and selects ‘message’ by the second input form (as illustrated in FIG. 42A). The user terminal recognizes that note content to be processed are ‘Hello’ and a function menu corresponding to the command is ‘message’ sending. The user terminal displays an icon indicating message sending in the vicinity of the note content ‘message’ corresponding to the command.

Because the user terminal should determine ‘to whom’ the message will be sent, the user terminal displays a message asking who is the recipient of the message, for example, ‘To whom shall I send it?’ (as illustrated in FIG. 42B).

As illustrated in FIG. 42C, when the user writes down ‘Jason’ on the screen by the memo function in response to the query message, the user terminal eventually recognizes that the user intends to send the message ‘Hello’ to Jason.

Subsequently, the user terminal detects a phone number corresponding to ‘Jason’ in a directory and sends ‘Hello’ to the phone number. The user terminal displays a message indicating successful sending of the message ‘Hello’ to ‘Jason’ on the screen (as illustrated in FIG. 42D).

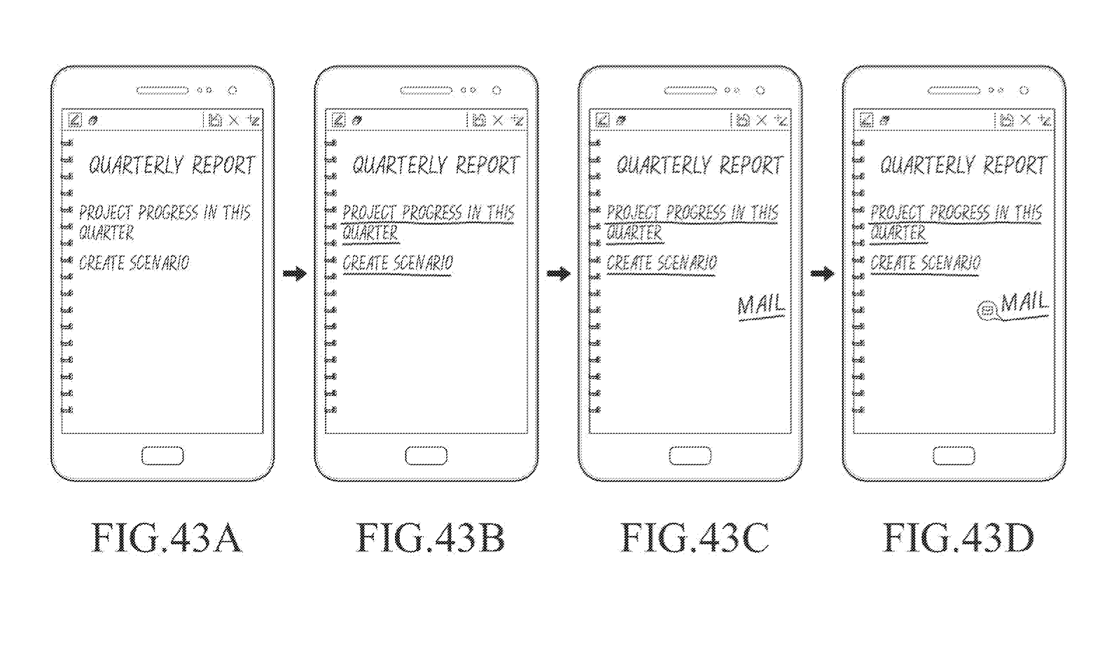

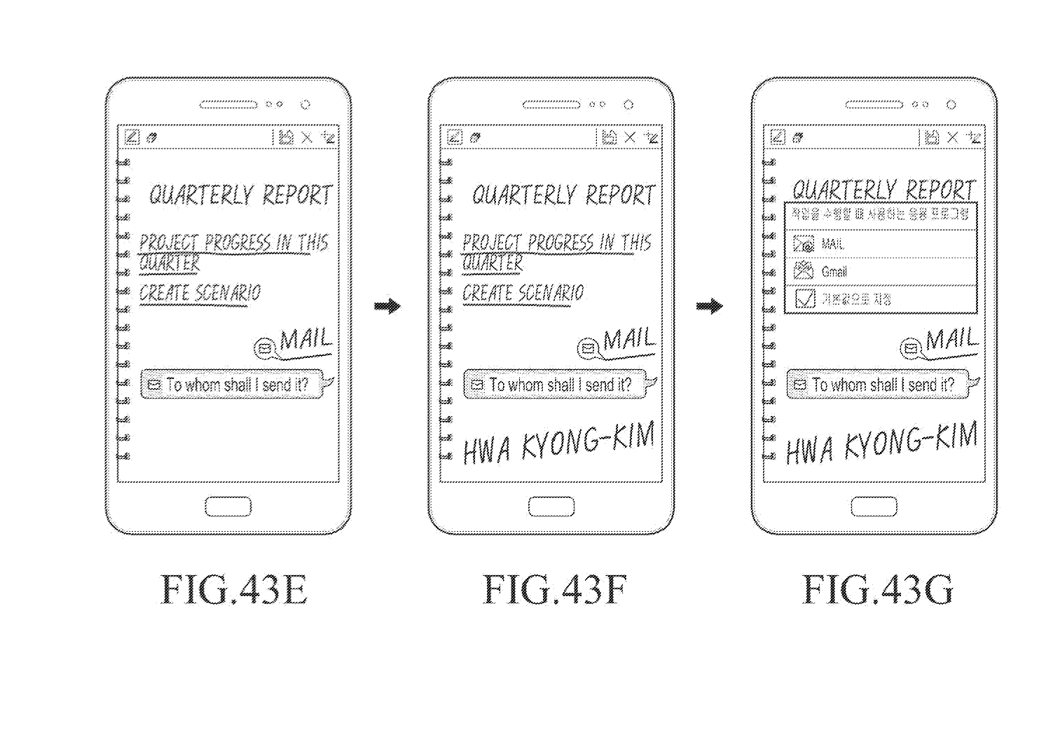

Referring to FIGS. 43A, 43B, 43C, 43D, 43E, 43F, and 43G, the user writes down ‘Quarterly Report project progress in this quarter create scenario’ (as illustrated in FIG. 43A) and then underlines ‘project progress in this quarter create scenario’ (as illustrated in FIG. 43B). Underlining ‘create scenario for project in this quarter’ corresponds to the first input form. Thus the user terminal recognizes that note content to be processed are ‘project progress in this quarter create scenario’.

The user writes down ‘mail’ by the memo function (as illustrated in FIG. 43C) and underlines ‘mail’, making a preliminary gesture preset as the second input form. For example, the preset preliminary gesture may be to keep the electronic pen touched in the vicinity of the note ‘mail’ for a predetermined time. Thus, the user terminal recognizes that the user intends to send ‘project progress in this quarter create scenario’ by mail. As illustrated in FIG. 43D, the user terminal then displays an icon representing the recognized command. For example, the user terminal displays an icon representing mail sending in the vicinity of the note content corresponding to the command.

However, the user terminal needs information about a mail recipient. Therefore, as illustrated in FIG. 43E, the user terminal displays a message asking who will receive the mail, for example, ‘To whom shall I send it?’.

When the user writes down “Hwa Kyong-KIM” by the memo function in response to the query message as illustrated in FIG. 43F, the user terminal recognizes that the user intends to send ‘create scenario for project in this quarter’ to Hwa Kyong-KIM by mail. Herein, the user terminal should check the presence or absence of a registered mail address matching with ‘Hwa Kyong-KIM’ in a directory. In the absence of the mail address, the user terminal prompts the user to enter the mail address of ‘Hwa Kyong-KIM’ and sends the mail to the mail address corresponding to an input received as a response.

If a plurality of mail addresses are available for ‘Hwa Kyong-KIM’, the user terminal needs to ask the user which one to select. Therefore, as illustrated in FIG. 43G, the user terminal displays a screen prompting the user to select between ‘default mail address’ and ‘Gmail address’.

Upon user selection of a specific mail address, the user terminal outputs an outgoing mail format for the selected mail address on the screen. The mail format includes the items of a user mail address, a recipient mail address, and a mail body.

Thus the user may amend or add information in the displayed mail format using a keypad or the like.

When the user requests to send the mail after filling the mail format, the user terminal sends the displayed mail.

Although not shown, upon completion of the mail sending, the user terminal outputs a message indicating completed sending of the mail on the screen so that the user may confirm the result of processing the requested command.

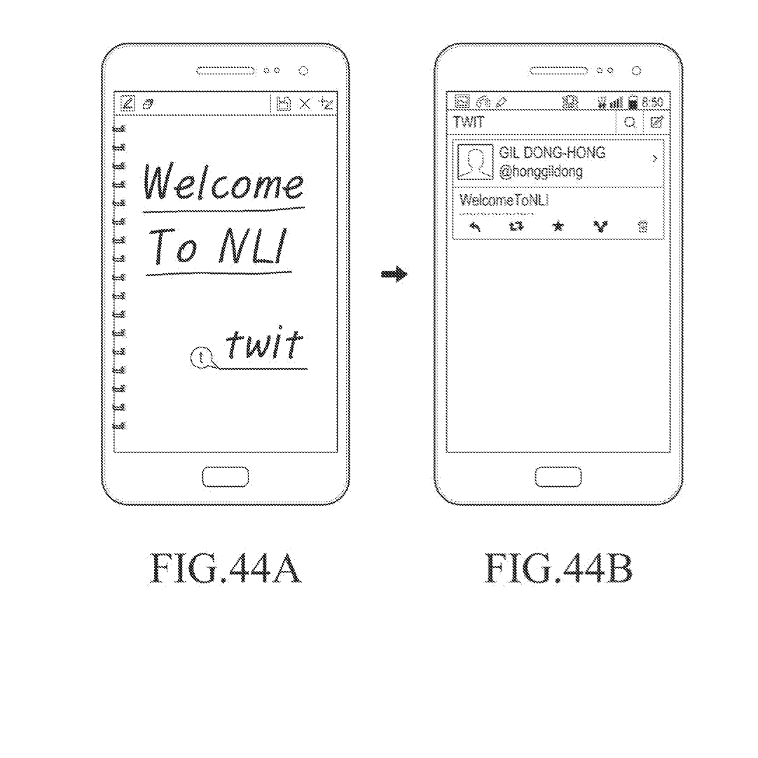

Referring to FIGS. 44A and 44B, the user writes down ‘Welcome to NLI’ and ‘twit’ on a screen by the memo function and then selects ‘Welcome to NLI’ and ‘twit’ respectively by the first and second input forms (as illustrated in FIG. 44A). Therefore, the user terminal recognizes that ‘Welcome to NLI’ is note content to be processed and a function menu corresponding to a command to be executed is to post information to ‘twit’. The user terminal displays an icon representing the recognized function menu. For example, the user displays an icon representing the ‘post information to twit’ in the vicinity of ‘twit’.

Recognizing that the user intends to post the message ‘Welcome to NLI’ to ‘twit’, the user terminal performs the recognized user-intended operation. The user terminal allows the user to confirm the result of processing the command by displaying the result of the operation on the screen (as illustrated in FIG. 44B).

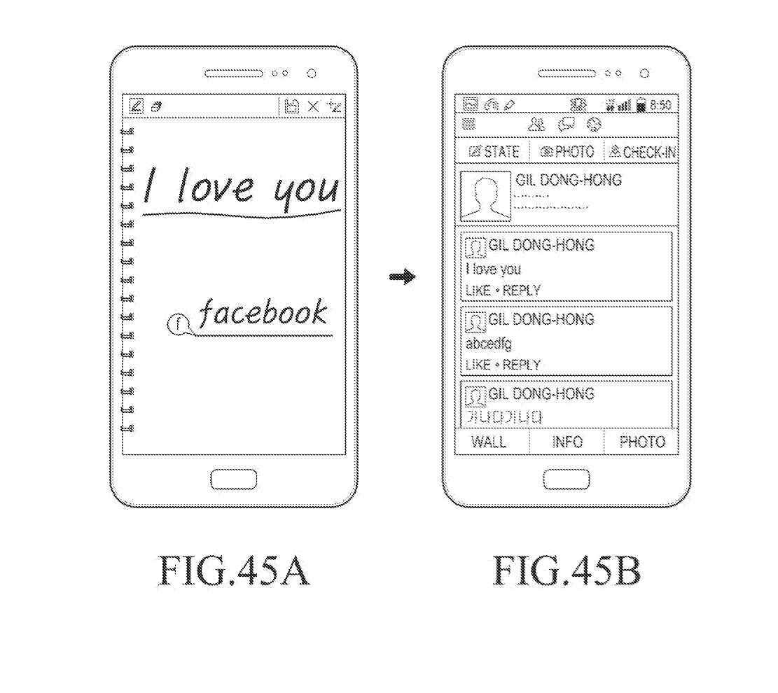

Referring to FIGS. 45A and 44B, the user writes down ‘I Love You’ and ‘facebook’ on a screen by the memo function and then selects ‘I Love You’ and ‘facebook’ respectively by the first and second input forms (as illustrated in FIG. 45A). Therefore, the user terminal recognizes that ‘I Love You’ corresponds to note content to be processed and a function menu corresponding to a command to be executed is to post information to ‘facebook’. The user terminal displays an icon representing the recognized function menu. For example, the user terminal displays an icon representing ‘post information to facebook’ in the vicinity of ‘facebook’.

Recognizing that the user intends to post the message ‘I Love You’ to ‘facebook’, the user terminal performs the recognized user-intended operation. The user terminal allows the user to confirm the result of processing the command by displaying the result of the operation on the screen (as illustrated in FIG. 45B).

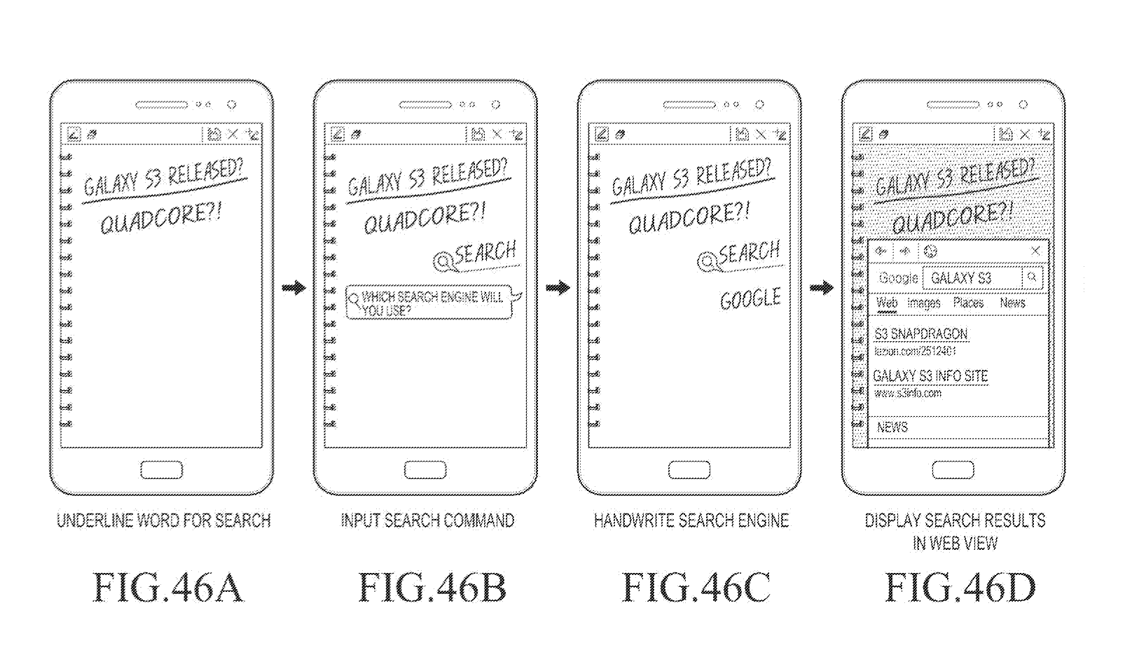

Referring to FIGS. 46A, 46B, 46C, and 46D, the user writes down ‘Galaxy S3 released? Quadcore?! . . . ’ on a screen by the memo function and then selects ‘Galaxy S3’ from ‘Galaxy S3 released? Quadcore?! . . . ’ by the first input form (as illustrated in FIG. 46A). Therefore, the user terminal recognizes that ‘Galaxy S3’ corresponds to note content to be processed.

The user writes down a note ‘search’ on the screen by the memo function and selects ‘search’ by the second input form. Thus, the user terminal recognizes that the note content to be processed are ‘Galaxy S3’ and a function menu corresponding to a command to be executed is ‘search’. The user terminal displays an icon representing the recognized function menu. For example, the user terminal displays an icon representing ‘search’ in the vicinity of ‘search’.

However, the user terminal determines that information about a search engine is additionally needed to ‘search’. Thus, the user terminal displays a message asking an intended search engine on the screen to acquire the additional information about the search engine. For example, the user terminal outputs a message ‘What search engine will you use?’ or ‘Google? Naver? Wikipedia?’ on the screen (as illustrated in FIG. 46B).

The user makes a note of information about an intended search engine by the memo function in response to the message. For example, if the user writes down ‘Google’ by the memo function, the user terminal recognizes that the user requests to use ‘Google’ as a search engine (as illustrated in FIG. 46C). While an input form for selecting ‘Google’ is not defined in FIGS. 46A, 46B, 46C, and 46D, ‘Google’ may be selected by the afore-defined first input form.

Recognizing that the user intends to search information about Galaxy 3 by Google, the user terminal performs the recognized user-intended operation. The user terminal allows the user to confirm the result of processing the command by displaying the result of the operation on the screen (as illustrated in FIG. 46D).

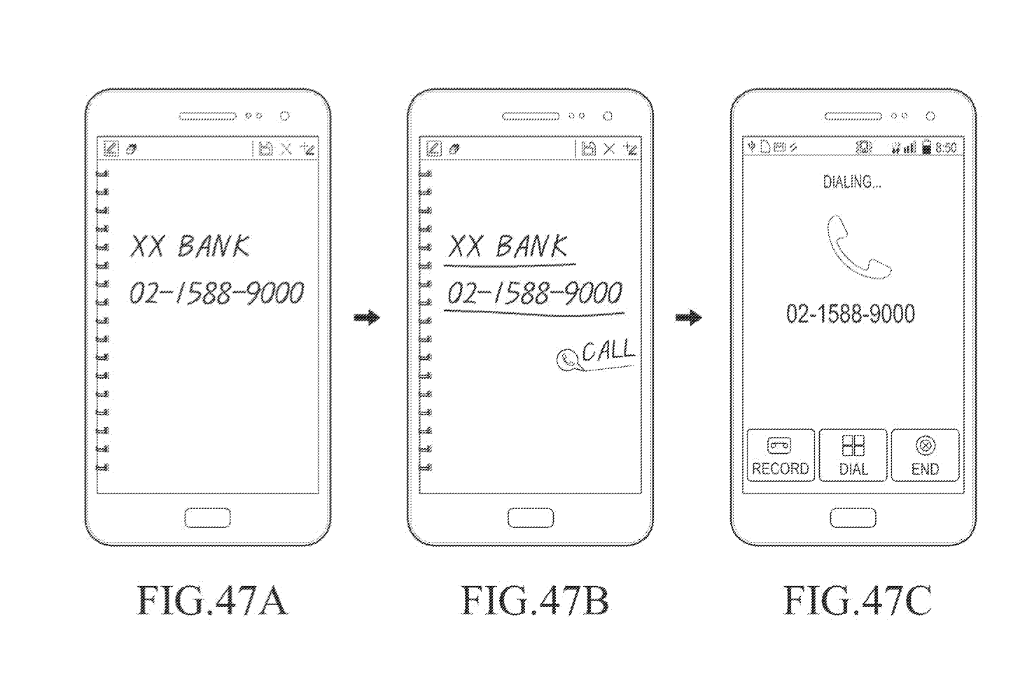

Referring to FIGS. 47A, 47B, and 47C, the user writes down ‘xx bank 02-1588-9000’ on a screen by the memo function (as illustrated in FIG. 47A). The user underlines ‘02-1588-9000’, writes down ‘call’, and then underlines ‘call’, making a preliminary gesture preset as the second input form (as illustrated in FIG. 47B). Underlining ‘02-1588-9000’ corresponds to the first input form. For example, the preset preliminary gesture may be to keep the electronic pen touched in the vicinity of the start of the note ‘call’ for a predetermined time.

Recognizing that the user intends to dial ‘02-1588-9000’, the user terminal displays an icon representing the recognized command in the vicinity of ‘call’.

The user terminal performs the recognized user-intended operation (as illustrated in FIG. 47C). For example, the user terminal dials ‘02-1588-9000’ after executing a function menu for a call.

Although the respective notes corresponding to note content to be processed and a command to be executed are separately made in FIG. 47, it is obvious that the two notes may be written down together and then selected respectively by the first and second input forms.

As is apparent from the above description of the present disclosure, a memo function can be actively used by means of an electronic pen or the like in a user terminal. As an intuitive interface is provided to a user, the user can conveniently use functions supported by the user terminal.

Furthermore, while a map application is activated, the user terminal determines information handwritten on a map screen and executes an associated function. Therefore, the user can use the map application through an intuitive interface.

It will be understood that the various embodiments of the present disclosure can be implemented in hardware, software, or a combination thereof. The software may be stored in a volatile or non-volatile memory device like a Read-Only Memory (ROM) irrespective of whether data is deletable or rewritable, in a memory like a Random-Access Memory (RAM), a memory chip, a device, or an integrated circuit, or in a storage medium to which data can be recorded optically or magnetically and from which data can be read by a machine (e.g. a computer), such as a CD, a DVD, a magnetic disk, a magnetic tape, or the like.

Further, the UI apparatus and method in the user terminal of the present disclosure can be implemented in a computer or portable terminal that has a controller and a memory, and the memory is an example of a non-transitory machine-readable (computer-readable) storage medium suitable for storing a program or programs including commands to implement the various embodiments of the present disclosure. Accordingly, the present disclosure includes a program having a code for implementing the apparatuses or methods defined by the claims and a storage medium readable by a machine that stores the program. The program can be transferred electronically through a medium such as a communication signal transmitted via a wired or wireless connection, which and the equivalents of which are included in the present disclosure.

The UI apparatus and method in the user terminal can receive the program from a program providing device connected by cable or wirelessly and store it. The program providing device may include a program including commands to implement the various embodiments of the present disclosure, a memory for storing information required for the various embodiments of the present disclosure, a communication module for communicating with the UI apparatus by cable or wirelessly, and a controller for transmitting the program to the UI apparatus automatically or upon request of the UI apparatus.

For example, it is assumed in the various embodiments of the present disclosure that a recognition engine configuring a UI analyzes a user's intention based on a recognized result and provides the result of processing an input based on the user intention to a user and these functions are processed within a user terminal.

However, it may be further contemplated that the user terminal executes functions required to implement the present disclosure in conjunction with a server accessible through a network. For example, the user terminal transmits a recognized result of the recognition engine to the server through the network. Then the server assesses the user's intention based on the received recognized result and provides the user's intention to the user terminal. If additional information is needed to assess the user's intention or process the user's intention, the server may receive the additional information by a question and answer procedure with the user terminal.

In addition, the user may limit the operations of the present disclosure to the user terminal or may selectively extend the operations of the present disclosure to interworking with the server through the network by adjusting settings of the user terminal.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A User Interface (UI) method at a user terminal, the UI method comprising:
providing a memo layer, while a map is displayed;
receiving a first-type input and a second-type input in the memo layer;
recognizing one of the first-type input and the second-type input as a handwriting input;
recognizing the other of the first-type input and the second-type input as a drawing input;
acquiring at least location information according to the handwriting input;
acquiring a drawing object area according to the drawing input; and
displaying, on the map, an indication of the at least the location information in the drawing object area.

2. The UI method of claim 1, wherein the acquiring of the at least the location information according to the handwriting input and the acquiring of the drawing object area according to the drawing input comprises:
acquiring handwriting information according to the handwriting input;
acquiring drawing object area information according to the drawing input;
transmitting the handwriting information and the drawing object area information to a server; and
receiving, from the server, information about an area corresponding to the drawing object area information and information about at least the location information included in the area according to the handwriting information.

3. The UI method of claim 1, wherein the acquiring of the at least location information according to the handwriting input and the acquiring of the drawing object area according to the drawing input comprises:
acquiring handwriting information according to the handwriting input;
transmitting the handwriting information and the information about a range of the map to a server; and
receiving, from the server, information about at least the location information included in the range of the map according to the handwriting information.

4. The UI method of claim 1, further comprising:
recognizing an additional drawing input;
acquiring information about an additional drawing object area according to the additional drawing input; and
displaying, within a range of the map, at least location information included in the additional drawing object area according to the handwriting information.

5. The UI method of claim 1, wherein the drawing input is a predetermined figure and the predetermined figure is a concentric circle.

6. The UI method of claim 5, wherein if the predetermined figure is not a concentric circle, the figure is transformed to a concentric circle.

7. The UI method of claim 1, wherein the recognizing of one of the first-type input and the second-type input as a handwriting input comprises:
determining an input to a first area of the memo layer as the first-type input, and
determining an input to a second area of the memo layer as the second-type input.

8. The UI method of claim 1, wherein the memo layer includes a first memo layer to receive the first-type input, and a second memo layer to receive the second-type input.

9. The UI method of claim 1, further comprising:
determining whether a third-type input corresponding to a drawing object movement request input has been received;
moving a drawing object according to the drawing object movement request input;
displaying the moved drawing object;
selecting an area corresponding to the moved drawing object; and
displaying location information included in the area corresponding to the moved drawing object from among the at least the location information.

10. The UI method of claim 1, wherein the first-type input is a touch input applied in a touch input mode, and the second-type input is a pen input applied in a pen input mode.

11. A User Interface (UI) apparatus at a user terminal, the UI method comprising:
a touch panel unit configured to activate a memo layer, while a map is displayed, and to receive a first-type input and a second-type input in the memo layer;
a command processor configured to recognize one of the first-type input and the second-type input as a handwriting input, and to recognize the other of the first-type input and the second-type input as a drawing input; and
an application executer configured to acquire at least location information according to the handwriting input, to acquire a drawing object area according to the drawing input, and to display, on the map, the at least the location information in the drawing object area.

12. The UI apparatus of claim 11, further comprising a communication module configured to communicate with a server,
wherein the application executer acquires handwriting information according to the handwriting input, acquires drawing object area information according to the drawing input, transmits the handwriting information and the drawing object area information to the server, and receives, from the server, information about an area corresponding to the drawing object area information and information about at least the location information included in the area according to the handwriting information.

13. The UI apparatus of claim 11, further comprising a communication module configured to communicate with a server,
wherein the application executer acquires handwriting information according to the handwriting input, transmits the handwriting information and the information about a range of the map to the server, and receives, from the server, information about at least the location information included in the range of the map according to the handwriting information.

14. The UI apparatus of claim 11, wherein the command processor recognizes an additional drawing input, and
wherein the application executer acquires information about an additional drawing object area according to the additional drawing input, and displays, within a range of the map, at least location information included in the additional drawing object area according to the handwriting information.

15. The UI apparatus of claim 11, wherein the drawing input is a predetermined figure and the predetermined figure is a concentric circle.

16. The UI apparatus of claim 15, wherein if the predetermined figure is not a concentric circle, the figure is transformed to a concentric circle.

17. The UI apparatus of claim 11, wherein the command processor determines an input to a first area of the memo layer as the first-type input and determines an input to a second area of the memo layer as the second-type input.

18. The UI apparatus of claim 11, wherein the memo layer includes a first memo layer to receive the first-type input and a second memo layer to receive the second-type input.

19. The UI apparatus of claim 11, wherein upon receipt of a third-type input corresponding to a drawing object movement request input, the application executer moves a drawing object according to the drawing object movement request input, displays the moved drawing object, selects an area corresponding to the moved drawing object, and displays location information included in the area corresponding to the moved drawing object from among the at least the location information.

20. The UI apparatus of claim 11, wherein the first-type input is a touch input applied in a touch input mode and the second-type input is a pen input applied in a pen input mode, and
wherein the touch panel unit includes a touch panel configured to receive the first-type input from a user and a pen recognition panel configured to receive the second-type input from the user.

21. A non-transitory computer-readable storage medium storing instructions, that when executed, cause at least one processor to perform the method of claim 1.
